(19) United States
(12) Patent Application Publication
(10) Pub. No.: US 2025/0251261 A1
(43) Pub. Date: Aug. 7, 2025

(54) MODULAR AIRFLOW SENSOR ARRAY

(71) Applicant: Campos Engineering Inc., Dallas, TX (US)

(72) Inventors: Joseph W. Campos, Dallas, TX (US); Dirk Thieme, Dallas, TX (US)

(21) Appl. No.: 19/046,801

(22) Filed: Feb. 6, 2025

Related U.S. Application Data
(60) Provisional application No. 63/550,444, filed on Feb. 6, 2024.

(51) Int. Cl. G01D 11/30; G01D 11/16; G01F 1/00

(52) U.S. Cl. CPC G01D 11/30; G01D 11/16; G01F 1/00

(57) ABSTRACT

The present disclosure is related to a modular airflow sensor array. The modular airflow sensor array that includes a set of airflow grids that each have one or more airflow passages along an extension that extends from the central point of the airflow grid. The airflow grids can be coupled to a measurement device that receive airflow from the extensions of the airflow grid. The extensions can have a lug at the end opposite of the central point. The lug allows for the airflow grid to be coupled to various connectors that can include a two-way connector or a four-way connector. The two-way connector can couple to a support assembly that allows for the airflow grids to secured and connected in a modular manner. The support assembly can be sized to fit the area to be measured, and then the desired number of airflow grids coupled to the frame.

### BACKGROUND

### Technical Field

The present disclosure relates to large-scale airflow measurement. More particularly, and not by way of limitation, the present disclosure is directed to a system and apparatus for the measurement of airflow from large-scale heating, ventilating, and air conditioning (HVAC) systems used in environmentally sensitive buildings.

### Description of Related Art

Many indoor environments have a climate control system that can heat, cool, or ventilate an indoor space to meet the comfort, and safety demands of the occupants, referred to as heating, ventilating, and air conditioning (HVAC). HVAC systems range in size and complexity, and engineers typically design, specify, and match the HVAC air or water system with the specific needs of the space at that moment in time, such as supplying conditioned air to a room to maintain a comfortable temperature for its occupants. Many systems consist of equipment that heats, cools, or ventilates air and moves the air with a fan through a system of ducts or coils. The ducts connect to a few or many grilles, an installed opening in a ceiling typically made of metal, that directs the conditioned air evenly throughout the space it serves. Each grille may require a different amount of airflow; therefore, before a grille, a device called a damper is opened or closed to control the amount of airflow that can come out of the grille. Other systems consist of equipment that heats or cools a fluid and moves the fluid with a pump through a system of pipes. The pipes connect to a few or many coils, a device used to transfer heat between two fluids such as water and air. Each coil may require a different amount of fluid flow; therefore, before or after a coil, a valve is opened or closed to control the amount of fluid that can flow through the coil. A few or many fans may be located before or after the coil to control the amount of air that can flow through the coil.

HVAC air and water systems require an initial testing phase to confirm that the installed system meets the specific requirements of the design. Tests can consist of measuring the amount of airflow or water flow to compare it with the amount specified by the engineer. When airflow or water flow values do not meet the amount specified, a process called balancing is used to adjust the airflow or water flow at a few or many grilles or coils by opening and closing the associated dampers or valves, or adjusting fan speeds until each grille or coil has the correct amount of airflow or water flow. The overall process commonly referred to as testing and balancing, is time-consuming because dampers or coils can be located above a ceiling or large in size, requiring a ladder for access. Additionally, the dampers, valves, coils, and grilles can be spread out over a large area requiring a lot of walking and movement of equipment. As a result, the individual or team testing and balancing a system must take an initial airflow or water flow measurement at a grille or coil, make adjustments, and walk a distance and climb up a ladder to measure the change in airflow or water flow. Unpredictable airflow or water flow changes result in a time-consuming iterative process of adjusting dampers, valves, or fans, walking, taking grille or coil readings, climbing ladders, taking more readings, until each grille or coil reading is within an acceptable range of the design values. Testing and balancing a single HVAC system can take hours and commercial buildings can have hundreds of HVAC systems requiring test and balance.

Data centers, hospitals, laboratories, and clean rooms and similar locations have some of the most sensitive locations for airflow. When airflow does not occur in the proper order or at the proper volume these facilities can have energy or critical infrastructure failures. When discussing hospitals if airflow does not occur then patients are at risk. When discussing data centers, if airflow is outside of design critical infrastructure are at risk and high unnecessary energy consumption can occur. It would be advantageous to have an apparatus or system for large scale airflow measurement that overcomes the disadvantages of the prior art. The present disclosure provides such an apparatus and system.

### BRIEF SUMMARY

The present disclosure is directed to a modular airflow sensor array apparatus, system, and method. Thus, in one aspect, the present disclosure is directed to a modular airflow sensor array that includes a set of airflow grids that each have one or more airflow passages along an extension that extends from the central point of the airflow grid. The extensions can have a lug at the end opposite of the central point. The lug allows for the airflow grid to be coupled to various connectors that can include a two-way connector or a four-way connector. The two-way connector can couple to a support assembly that allows for the airflow grids to secured and connected in a modular manner.

In another aspect, the present disclosure is directed to the assembly of an airflow sensor array. The airflow sensor array can have a frame that is sized to fit the area to be measured, and then fitting the desired number of airflow grids to the frame. The airflow grids can be coupled to a measurement device that receive airflow from the extensions of the airflow grid. The airflow grid extension can extend from a central point with a lug at the end that is opposite the central point, and the lug allow for engaging with a connector.

Other aspects, embodiments and features of the present disclosure will become apparent from the following detailed description when considered in conjunction with the accompanying figures. In the figures, each identical, or substantially similar component that is illustrated in various figures is represented by a single numeral or notation. For purposes of clarity, not every component is labeled in every figure. Nor is every component of the disclosure shown where illustration is not necessary to allow those of ordinary skill in the art to understand the disclosure.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective view illustration of a modular airflow sensor array.

FIG. 2 is a zoomed front view of a modular airflow sensor array with a frame and two-way connector.

FIG. 3 is a zoomed front view of a modular airflow sensor array.

FIG. 4 is a front view of a modular airflow sensor array.

FIG. 5 is a perspective view illustration of an airflow grid.

FIG. 6 is a front view illustration of an airflow grid.

FIG. 7A is a rear perspective view illustration of a two-way connector.

FIG. 7B is a front perspective view illustration of a two-way connector.

FIG. 8A is a side perspective view illustration of a four-way connector.

FIG. 8B is bottom perspective view illustration of a four-way connector.

FIG. 8C is a front view illustration of a four-way connector.

FIG. 9A illustrates a schematic HVAC airflow and water flow system and major components of the intelligent balancing system.

FIG. 9B illustrates a tree schematic representation of network communication.

FIG. 9C illustrates a mesh schematic representation of network communication.

FIG. 10A illustrates the data user interface.

FIG. 11A illustrates the output node with a schematic diagram of a typical HVAC damper or valve and ductwork or pipe layout.

FIG. 11B illustrates an alternative view of the output node enclosure.

FIG. 11C illustrates an alternative view of the output node enclosure.

FIG. 12 illustrates the flow node.

FIG. 13A illustrates the flow node attached to the magnetic capture hood.

FIG. 13B illustrates the magnetic capture hood.

FIG. 14 illustrates the utility cart is used to store, transport, and charge the intelligent wireless test and balance system.

FIG. 15A is a right-side perspective view of a modular multi-chamber airflow grid.

FIG. 15B is a left-side perspective view of a modular multi-chamber airflow grid.

FIG. 15C is a top view of a modular multi-chamber airflow grid.

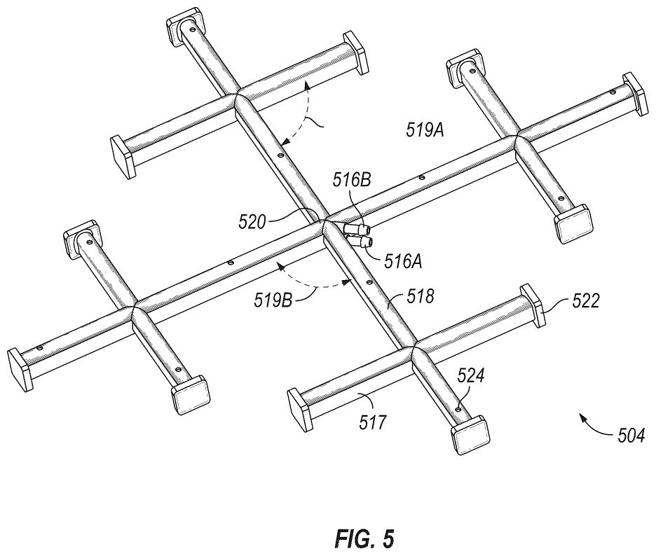

FIG. 5D is a bottom view of a modular multi-chamber airflow grid.

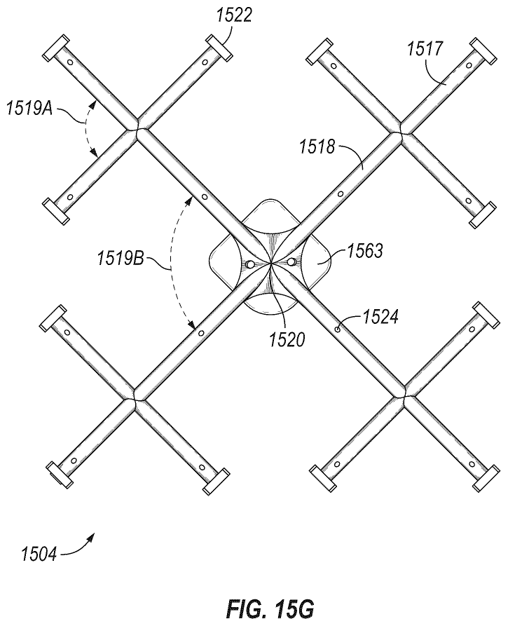

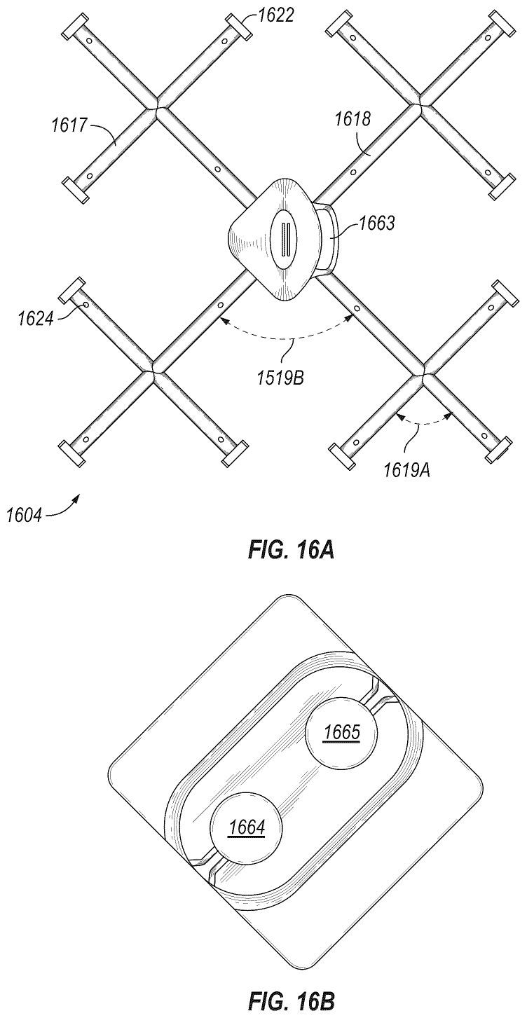

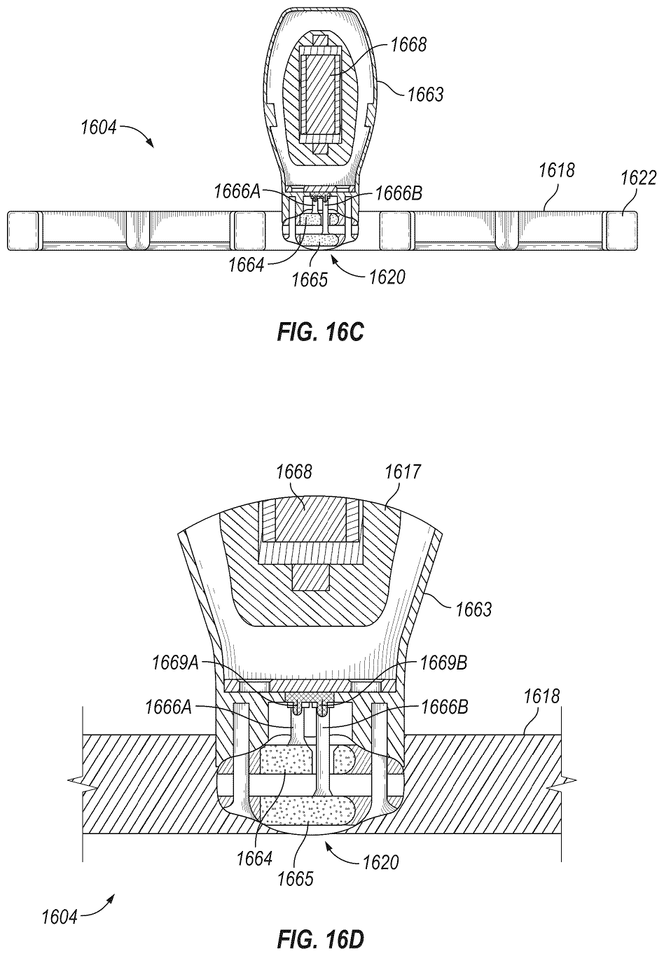

FIG. 15E is a right-side view of a modular multi-chamber airflow grid.

FIG. 15F is a left-side view of a modular multi-chamber airflow grid.

FIG. 15G is a front view of a modular multi-chamber airflow grid.

FIG. 16A is a rear view of a modular multi-chamber airflow grid.

FIG. 16B is a cut-away view of an airflow grid extension(s) of the modular multi-chamber airflow grid.

FIG. 16C is a cutaway top view of a modular multi-chamber airflow grid.

FIG. 16D is a zoomed-in cutaway top view of a modular multi-chamber airflow grid.

### DETAILED DESCRIPTION

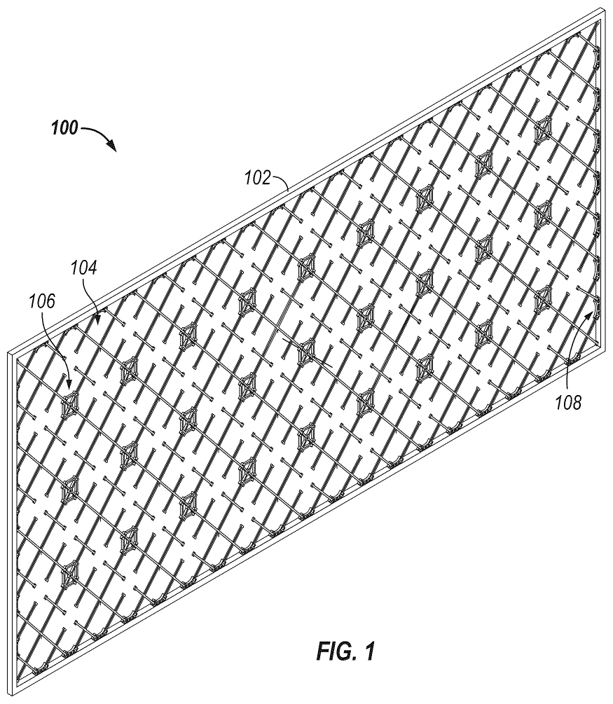

Embodiments of the disclosure will now be described. FIG. 1 is a perspective view illustration of a modular airflow sensor array 100. The modular airflow sensor array 100 is utilized to measure large-scale airflow, whereas traditional measurement tools can result in errors and mistakes. For example, when a data center needs airflow measurements across its large fan array, a standard airflow grid and measurement node when measurements are taken approximately every one foot if the person (user) taking the measurements gets off by even a few inches when they are several feet down the line any adjustments made could be based on incorrect data to the wrong bank of fans, vents, chillers, or other HVAC unit. A data center can be a facility used to house computing devices or systems and associated components, such as telecommunications and data storage devices or systems. A data center is often designed to support large-scale data processing, storage, and distribution for enterprises, government agencies, and cloud service providers, while the use of data centers for other industries has increased in the last few years and is in the forefront of consideration with the increased development of Artificial Intelligence projects. The main components of a data center are servers (computing devices with processors, processing cores, and/or other technology for efficiently moving large amounts of data and performing operations on data). These servers require precise temperature, humidity, and airflow management to maintain optimal performance, prevent hardware failure, and ensure energy efficiency. The high-density computing components can generate substantial heat that needs to be removed and/or routed to minimize energy waste. These temperature, humidity, and airflow system can include air conditioning, other cooling systems (such as but not limited to geothermal or liquid systems), heat exchangers, fan systems, and/or other devices or systems that allow for changes in temperature, humidity, or airflow. Accordingly, because of the large-scale operations of some data centers, an error in airflow measurements can result in large changes to energy demands and, ultimately, significant changes to the costs of operating these data centers. Therefore, a need has arisen for modular airflow sensor array(s) 100, like that shown, that can be modified to take measurements of multiple fan arrays.

In order to support the expansion of the modular airflow sensor array 100, a frame 102 can be utilized to provide a connection point for additional portions of the modular airflow sensor array 100, as well as allow for them to be lifted or positioned. In some examples, the frame 102 may be a support assembly that can include frame components. The frame 102 may have channels or grooves that allow for other attachment mechanisms, devices, and/or systems to engage or interact with the frame 102. These channels can receive different shapes and/or types of posts, or outcroppings that allow for engagement and/or interaction.

An airflow grid 104 can be coupled through a set of connectors such as a four-way connector 106 or a two-way connector 108. It would be understood that a set can include one or more and can also contain a combination of two-way or four-way connectors. The airflow grid 104 allows for a measurement of airflow over a known surface area. In some examples, an airflow grid may also be known as an airflow measurement grid or air grid. In addition to airflow, the velocity of air movement across the airflow grid 104 may also be measured. The airflow grid 104 may be positioned in proximity to a vent, duct (sometimes referenced as ductwork), or opening that is coupled to a fan. In some embodiment, a set of airflow grids 104 may be utilized in conjunction with one another to measure across a large area of airflow that may be a plurality or a set of vents, ducts, or openings. The airflow grid 104 may also include other environmental sensors or monitors in addition to airflow.

The four-way connector 108 is a connector that can receive portions of at least one airflow grid 104, and may connect with up to four airflow grids 104. In some examples, the four-way connector 106 may be utilized to allow for two or three airflow grids 104 to be coupled to the frame or other connectors. The four-way connector 106 can have an engagement area capable of receiving or coupling with a lug or other connection point of an airflow grid 104. In some embodiments, the four-way connector 106 may indirectly engage with the frame 102 through a two-way connector 108, other elements, or connection devices.

Similar to the four-way connector 106, a two-way connector 108 may be utilized to receive or engage with an airflow grid 104, the frame 102, or other connectors or connection devices. In at least one example, the two-way connector 108 can couple to the frame 102 through a fastening device or system, and also at least one airflow grid 104. However, the two-way connector 108 may be coupled to two airflow grids 104 as well in other examples. The two-way connector 108 can have an engagement area capable of receiving or coupling with a lug or other connection point of an airflow grid 104. Additionally, the two-way connector 108 may be configured to indirectly engage with a four-way connector 106 through a connection device or system. It would be understood that each of the four-way connectors 106 and the two-way connector 108 may couple directly or indirectly with the frame 102 or components of the frame 102.

As illustrated in this figure, there can be multiple airflow grids 104, four-way connectors 106, and two-way connectors 108 within a frame 102 of a modular airflow sensor array 100. In some examples, the frame 102 is modular, which means that it can be modified to allow for the desired number of airflow grids 104 in any configuration. In at least one embodiment, if the frame 102 is viewed as a grid with columns and rows, the frame can be as small as 1×2 (alternatively 2×1) meaning 1 column and 2 rows (alternatively 2 columns and 1 row), and be expanded as desired, but preferably not beyond a 20×20 grid. However, there is a possibility with additional support or support structure a 100×100 version of the frame 102 could be utilized. It would be understood that when discussed herein a 1×2 (alternatively 2×1) frame would allow for two airflow grids 104 to be utilized, similarly a 20×20 grid would allow for 400 airflow grids 104 to be utilized.

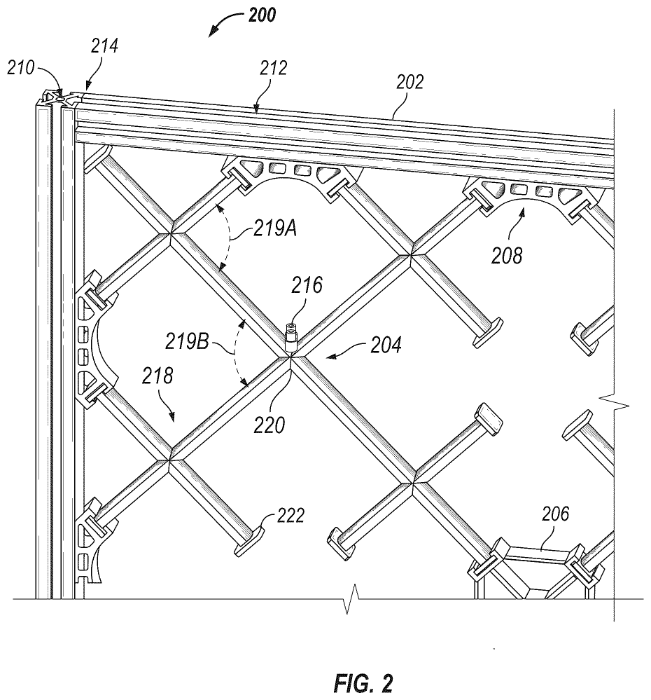

FIG. 2 is a zoomed front view of a modular airflow sensor array 200 with a frame 202 and two-way connector 208. The modular airflow sensor array 200 is utilized to measure large-scale airflow where traditional measurement tools can result in errors and mistakes. For example, when a data center needs airflow measurements across its large fan array, a standard airflow grid and measurement node when measurements are taken approximately every one foot if the person (user) taking the measurements gets off by even a few inches when they are several feet down the line any adjustments made based on incorrect data. In order to support the expansion of the modular airflow sensor array 200, a frame 202 can be utilized to provide a connection point for additional portions of the modular airflow sensor array 200, as well as allow for them to be lifted or positioned. In some examples, this could be with some type of scissor, fork, industrial, positional, winch, or other lift apparatus or trucks.

Frame 202, in at least one embodiment, is formed from a metal or reinforced polymer (in some versions may include plastic or other plastic-like materials) that can have a frame center or void 210. In some examples, the frame center 210 can be hollow or be a void that can accept or receive a reinforcing device or piece that can allow for multiple sections of a frame to be coupled or engaged together. Additionally, there can also be an engagement ring that goes around the frame 202 at the coupling point. The frame 202 can have a frame groove 212 along its length that allows for fasteners or fastening systems to engage or otherwise couple to the frame 202. The frame grove 212 may extend along only a portion of the frame 202 or along the entire length of the frame 202. A frame coupling 214 may allow for the frame lengths to be coupled together at a specified angle. While shown as a ninety (90) degree angle, it would be understood that other angles such as, but not limited to, 15, 30, 45, 60, 75, 90, 105, 120, 135, 150, 165, or 180 may be utilized.

An airflow grid 204 can be coupled through a set of connectors such as a four-way connector 206 or a two-way connector 208. It would be understood that a set can include one or more and can also contain a combination of two-way or four-way connectors. The airflow grid 204 can have an airflow grid center point 220 that allows for airflow grid extensions 218 to extend from it. While the airflow grid extensions 218 are shown at right angles (or ninety (90) degrees) 219A/219B from each other, other angles may be used for more or fewer extensions. It would be understood that other angles can include but are not limited to 15, 30, 45, 60, 75, 90, 105, 120, 135, 150, 165, or 180 degrees. At the end of the airflow grid extension(s) 218 can be an airflow grid lug 222 (may be referenced as a lug or grid lug). The airflow grid lug 222 allows the airflow grid 202 to be engaged or coupled to a set of connectors, such as but not limited to, the four-way connector 206 or the two-way connector 208.

The airflow grid 204 allows for a measurement of airflow over a known surface area. In some examples, an airflow grid may also be known as an airflow measurement grid or air grid. In addition to airflow, the velocity of air movement across the airflow grid 204 may also be measured. The airflow grid 204 may be positioned in proximity to a vent, duct (sometimes referenced as ductwork), or opening that is coupled to a fan. At the center of the airflow grid 204 is an airflow grid center point 220, and adjacent to the airflow grid center point 220 is the airflow coupling point 216 that allows for airflow measurements to be provided to an airflow sensor (not shown). In some examples, there may be multiple measurement points along the airflow grid 204 that can be fluidly coupled to the airflow coupling point 216. In some embodiment, a set of airflow grids 204 may be utilized in conjunction with one another to measure across a large area of airflow that may be a plurality or a set of vents, ducts, or openings.

As illustrated in this figure, there can be multiple airflow grids 204, four-way connectors 206, and two-way connectors 208 within a frame 202 of a modular airflow sensor array 200. In some examples, the frame 202 is modular, which means that it can be modified to allow for the desired number of airflow grids 204 in any configuration. In at least one embodiment, if the frame 202 is viewed as a grid with columns and rows, the frame can be as small as 1×2 (alternatively 2×1), and be expanded as desired, but preferably not beyond a 20×20 grid. However, there is a possibility with additional support or support structure a 100×100 version of the frame 202 could be utilized. It would be understood that when discussed herein a 1×2 (alternatively 2×1) frame would allow for two airflow grids 204 to be utilized, similarly a 20×20 grid would allow for 400 airflow grids 204 to be utilized.

The four-way connector 208 is a connector that can receive portions of at least one airflow grid 204, and may connect with up to four airflow grids 204. In some examples, the four-way connector 206 may be utilized to allow for two or three airflow grids 204 to be coupled to the frame or other connectors. The four-way connector 206 can have an engagement area capable of receiving or coupling with a lug or other connection point of an airflow grid 204. In some embodiments, the four-way connector 206 may indirectly engage with the frame 202 through a two-way connector 208, other elements, or connection devices.

Similar to the four-way connector 206, a two-way connector 208 may be utilized to receive or engage with an airflow grid 204, the frame 202, or other connectors or connection devices. In at least one example, the two-way connector 208 can couple to the frame 202 through a fastening device or system, and also at least one airflow grid 204. However, the two-way connector 208 may be coupled to two airflow grids 204 as well in other examples. The two-way connector 208 can have an engagement area capable of receiving or coupling with a lug or other connection point of an airflow grid 204. Additionally, the two-way connector 208 may be configured to indirectly engage with a four-way connector 106 through a connection device or system.

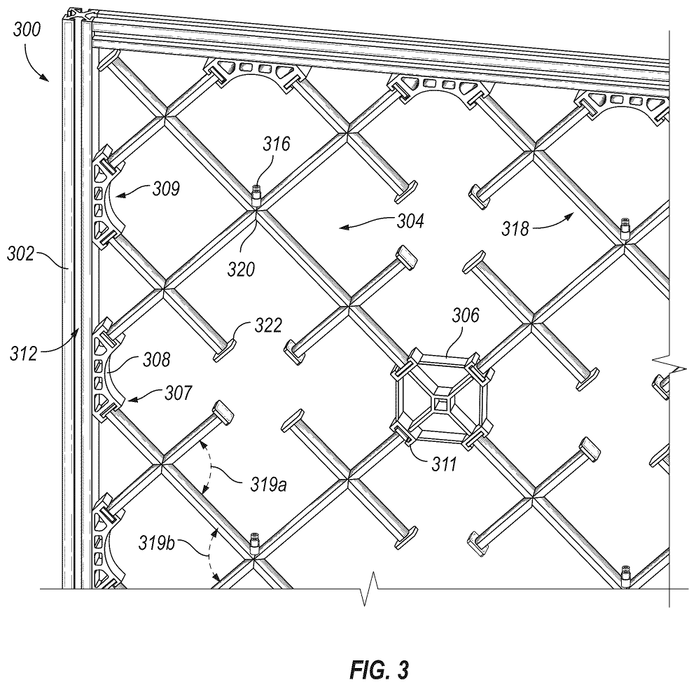

FIG. 3 is a zoomed front view of a modular airflow sensor array 300. The modular airflow sensor array 300 is utilized to measure large-scale airflow where traditional measurement tools can result in errors and mistakes. For example, when a data center needs airflow measurements across its large fan array, a standard airflow grid and measurement node when measurements are taken approximately every one foot if the person (user) taking the measurements gets off by even a few inches when they are several feet down the line any adjustments made could be based on incorrect data. In order to support the expansion of the modular airflow sensor array 300, a frame 302 can be utilized to provide a connection point for additional portions of the modular airflow sensor array 300, as well as allow for them to be lifted or positioned. In some examples, this could be with some type of scissor, fork, industrial, positional, winch, or other lift apparatus or trucks.

The frame 302, in at least one embodiment, is formed from a metal or reinforced polymer (in some versions may include plastic or other plastic like materials). The frame 302 can have a frame groove 312 along its length that allows for fasteners or fastening systems to engage or otherwise couple to the frame 302. The frame grove 312 may extend along only a portion of the frame 302 or along the entire length of the frame 302.

An airflow grid 304 can be coupled through a set of connectors such as a four-way connector 306 or a two-way connector 308. It would be understood that a set can include one or more and can also contain a combination of two-way or four-way connectors. The airflow grid 304 can have an airflow grid center point 320 that allows for airflow grid extensions 318 to extend from it. While the airflow grid extensions 318 are shown at right angles (or ninety (90) degrees) 319A/319B from each other, other angles may be used for more or fewer extensions. It would be understood that other angles can include but are not limited to 15, 30, 45, 60, 75, 90, 105, 120, 135, 150, 165, or 180 degrees. At the end of the airflow grid extension(s) 318 can be an airflow grid lug 322 (may be referenced as a lug or grid lug). The airflow grid lug 322 allows the airflow grid 302 to be engaged or coupled to a set of connectors, such as but not limited to, the four-way connector 306 or the two-way connector 308.

The two-way connector 308 can include a connection void 309 that allows for a fastener or fastener system (not shown) to couple the two-way connector 308 to the frame 302. Additionally, the modular airflow sensor array 300 can have an airflow grid 304 that couples to a two-way connector at an engagement point 307, and the airflow grid 304 may also couple to the four-way connector 306 via a coupling point 311. The engagement point 307 and the coupling point 311, while similar can support the airflow grid 304 in different manners.

In some examples, an airflow grid may also be known as an airflow measurement grid or air grid. In addition to airflow, the velocity of air movement across the airflow grid 304 may also be measured. The airflow grid 304 may be positioned in proximity to a vent, duct (sometimes referenced as ductwork), or opening that is coupled to a fan. At the center of the airflow grid 304 is an airflow grid center point 320, and adjacent to the airflow grid center point 320 is the airflow coupling point 316 that allows for airflow measurements to be provided to an airflow sensor (not shown). In some examples, there may be multiple measurement points along the airflow grid 304 that can be fluidly coupled to the airflow coupling point 316. In some embodiment, a set of airflow grids 304 may be utilized in conjunction with one another to measure across a large area of airflow that may be a plurality or a set of vents or ducts or openings. The airflow grid 304 allows for a measurement of airflow over a known surface area. If the measurements from the airflow coupling point(s) 316 do not match across the known surface area, then a team can determine if there are issues with a particular fan, duct system, and/or other components.

As illustrated in this figure, there can be multiple airflow grids 304, four-way connectors 306, and two-way connectors 308 within a frame 302 of a modular airflow sensor array 300. In some examples, the frame 302 is modular, which means that it can be modified to allow for the desired number of airflow grids 304 in any configuration. In at least one embodiment, if the frame 302 is viewed as a grid with columns and rows, the frame can be as small as 1×2 (alternatively 2×1), and be expanded as desired, but preferably not beyond a 20×20 grid. However, there is a possibility with additional support or support structure a 100×100 version of the frame 302 could be utilized. It would be understood that when discussed herein a 1×2 (alternatively 2×1) frame would allow for two airflow grids 304 to be utilized, similarly a 20×20 grid would allow for 400 airflow grids 304 to be utilized.

The four-way connector 308 is a connector that can receive portions of at least one airflow grid 304, and may connect with up to four airflow grids 304. In some examples, the four-way connector 306 may be utilized to allow for two or three airflow grids 304 to be coupled to the frame or other connectors. The four-way connector 306 can have an engagement area capable of receiving or coupling with a lug or other connection point of an airflow grid 304. In some embodiments, the four-way connector 306 may indirectly engage with the frame 302 through a two-way connector 308, other elements, or connection devices.

Similar to the four-way connector 306, a two-way connector 308 may be utilized to receive or engage with an airflow grid 304, the frame 302, or other connectors or connection devices. In at least one example, the two-way connector 308 can couple to the frame 302 through a fastening device or system, and also at least one airflow grid 304. However, the two-way connector 308 may be coupled to two airflow grids 304 as well in other examples. The two-way connector 308 can have an engagement area capable of receiving or coupling with a lug or other connection point of an airflow grid 304. Additionally, the two-way connector 308 may be configured to indirectly engage with a four-way connector 306 through a connection device or system.

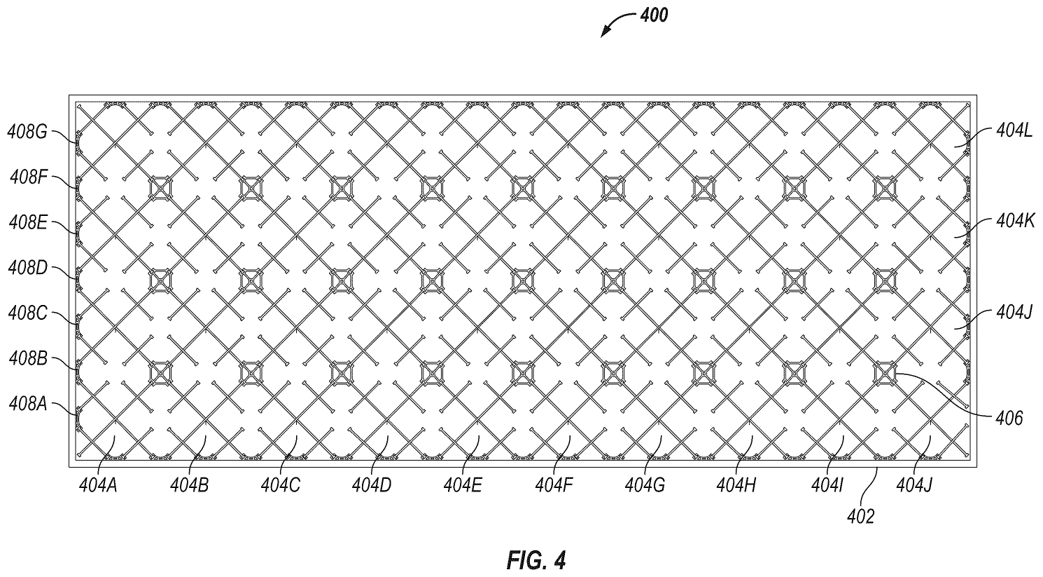

FIG. 4 is a front view of a modular airflow sensor array 400. The modular airflow sensor array 400 is utilized to measure large-scale airflow where traditional measurement tools can result in errors and mistakes. In order to support the expansion of the modular airflow sensor array 400, a frame 402 can be utilized to provide a connection point for additional portions of the modular airflow sensor array 400, as well as allow for them to be lifted or positioned. In some examples, this could be with some type of scissor, fork, industrial, positional, winch, or other lift apparatus or trucks.

An airflow grid 404 (404 is the collective references of airflow grids 404A/404B/404C/404D/404E/404F/404G/404H/404I (row) 404I/404J/404K/404L (column)) can be coupled through a set of connectors such as a four-way connector 406 or a two-way connector 408A/408B/408C/408D/408E/408F/408G (408 is the collective references of two-way connector). It would be understood that a set can include one or more and can also contain a combination of two-way or four-way connectors.

As illustrated in this figure, there can be multiple airflow grids 404, four-way connectors 406, and two-way connectors 408 within a frame 402 of a modular airflow sensor array 400. In some examples, the frame 402 is modular, which means that it can be modified to allow for the desired number of airflow grids 404 in any configuration. In at least one embodiment, if the frame 402 is viewed as a grid with columns and rows, the frame can be as small as 1×2 (alternatively 2×1), and be expanded as desired, but preferably not beyond a 20×20 grid. However, there is a possibility with additional support or support structure a 100×100 version of the frame 402 could be utilized. It would be understood that when discussed herein a 1×2 (alternatively 2×1) frame would allow for two airflow grids 404 to be utilized, similarly a 20×20 grid would allow for 400 airflow grids 404 to be utilized. In FIG. 4, there are nine airflow grids shown along a row, and there are five airflow grids shown along a column (airflow grids 404A/404B/404C/404D/404E/404F/404G/404H/404I (row) 404I/404J/404K/404L (column) collectively airflow grids 404).

The four-way connector 408 is a connector that can receive portions of at least one airflow grid 404, and may connect with up to four airflow grids 404. In some examples, the four-way connector 406 may be utilized to allow for two or three airflow grids 404 to be coupled to the frame or other connectors. The four-way connector 406 can have an engagement area capable of receiving or coupling with a lug or other connection point of an airflow grid 404. In some embodiments, the four-way connector 406 may indirectly engage with the frame 402 through a two-way connector 408, other elements, or connection devices.

Similar to the four-way connector 406, a two-way connector 408 may be utilized to receive or engage with an airflow grid 404, the frame 402, or other connectors or connection devices. In at least one example, the two-way connector 408 can couple to the frame 402 through a fastening device or system, and also at least one airflow grid 404. However, the two-way connector 408 may be coupled to two airflow grids 404 as well in other examples. The two-way connector 408 can have an engagement area capable of receiving or coupling with a lug or other connection point of an airflow grid 404. Additionally, the two-way connector 408 may be configured to indirectly engage with a four-way connector 406 through a connection device or system.

These rows and columns of airflow grid 404 allow for the positioning within a specified area to allow for measurements. The airflow grid 404 may be positioned in proximity to a vent, duct (sometimes referenced as ductwork), or opening that is coupled to a fan. In some examples, there may be multiple measurement points along the airflow grid 404 that can be fluidly coupled to the airflow coupling point (not illustrated). In some embodiment, a set of airflow grids 404 may be utilized in conjunction with one another to measure across a large area of airflow that may be a plurality or a set of vents, ducts, or openings.

FIG. 5 is a perspective view illustration of an airflow grid 504. The airflow grid 504 can have an airflow grid center point 520 that allows for airflow grid extensions 518 to extend from it. While the airflow grid extensions 518 are shown at right angles (or ninety (90) degrees) 519A/519B from each other, other angles may be used for more or fewer extensions. It would be understood that other angles can include but are not limited to 15, 30, 45, 60, 75, 90, 105, 120, 135, 150, 165, or 180 degrees. At the end of the airflow grid extension(s) 518 can be an airflow grid lug 522 (may be referenced as a lug or grid lug). The airflow grid lug 522 allows the airflow grid 502 to be engaged or coupled to a set of connectors, such as but not limited to, the four-way connector or the two-way connector. In at least one embodiment, the airflow grid 504 can have four airflow grid extensions 518 and each airflow grid extension 518 can have a grid branches 517. As shown these grid branches 517 are set at 90 degrees from each of the airflow grid extension 518. In the present disclosure, there can be a first grid branch 517 opposite a second grid branch, where the grid branch(es) 517 are perpendicular to the airflow grid extensions 518. When the grid branch(es) 517 are perpendicular to the airflow grid extensions they may be referenced or called a cross member. While grid branch(es) 517 are shown set at 90 degrees from each of the airflow grid extensions 518, it would be understood that they could be placed at any angle from 0 to 180 degrees. It would be understood that other angles can include but are not limited to 15, 30, 45, 60, 75, 90, 105, 120, 135, 150, 165, or 180 degrees.

The airflow grid 504 allows for a measurement of airflow over a known surface area. In some examples, an airflow grid may also be known as an airflow measurement grid or air grid. In addition to airflow, the velocity of air movement across the airflow grid 504 may also be measured. These measurements can be conducted through an airflow grid measurement point(s) 524. In at least one example, each of the airflow grid extension(s) 518 and each of the grid branch(es) 517 can have an airflow grid measure point 524.

The airflow grid 504 may be positioned in proximity to a vent, duct (sometimes referenced as ductwork), or opening that is coupled to a fan. At the center of the airflow grid 504 is an airflow grid center point 520, and adjacent to the airflow grid center point 520 is the airflow coupling point 516A/516B that allow for airflow measurements to be provided to an airflow sensor (not shown). The airflow coupling point(s) 516A/516B allow for airflow to be received by the airflow grid measurement point(s) 524 and passed between the two airflow coupling point(s) 516A/516B. In some examples, there may be multiple measurement points along the airflow grid 504 that can be fluidly coupled to the airflow coupling point 516A/516B. In some embodiment, a set of airflow grids 504 may be utilized in conjunction with one another to measure across a large area of airflow that may be a plurality or a set of vents, ducts, or openings.

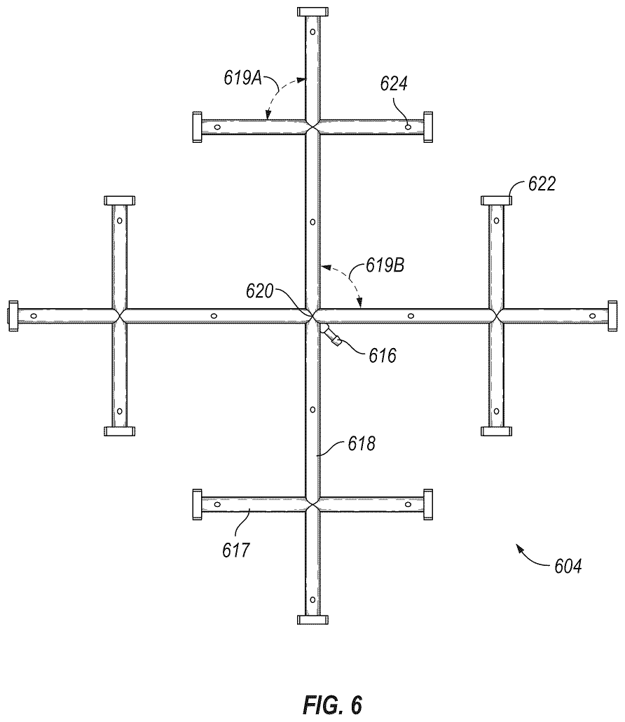

FIG. 6 is a front view illustration of an airflow grid 604. The airflow grid 604 can have an airflow grid center point 620 that allows for airflow grid extensions 618 to extend from it. While the airflow grid extensions 618 are shown at right angles (or ninety (90) degrees) 619A/619B from each other, other angles may be used for more or fewer extensions. It would be understood that other angles can include but are not limited to 15, 30, 45, 60, 75, 90, 105, 120, 135, 150, 165, or 180 degrees. In at least one embodiment, there can be four airflow grid extensions(s) 618, where each of the extensions are set ninety (90) degrees from each other. Meaning that the first extension is at 0 degrees, the second extension is at 90 degrees, the third extension is at 180 degrees, and the fourth extension is at 270 degrees.

At the end of the airflow grid extension(s) 618 can be an airflow grid lug 622 (may be referenced as a lug or grid lug). The airflow grid lug 622 allows the airflow grid 604 to be engaged or coupled to a set of connectors, such as but not limited to, the four-way connector or the two-way connector. In at least one embodiment, the airflow grid 604 can have four airflow grid extensions 618 and each airflow grid extension 618 can have a grid branches 617. As shown these grid branches 617 are set at 90 degrees from each of the airflow grid extension 618. In the present disclosure, there can be a first grid branch 617 opposite a second grid branch, where the grid branch(es) 617 are perpendicular to the airflow grid extensions 618. This means that a first grid branch at 90 degrees to the airflow grid extension 618, and then a second grid branch is at 180 degrees from the first grid branch, and 270 degrees from the airflow grid extensions.

From the airflow grid center point 620, each airflow grid extension(s) 618 extends outwardly. Each of the airflow grid extensions are at ninety (90) degrees from one another. Meaning that there is a first airflow grid extension at 0 degrees, a second airflow grid extension at 90 degrees, a third airflow grid extension at 180 degrees, and a fourth airflow grid extension at 270 degrees. At the end of each airflow grid extension 618 that is opposite the airflow grid center point 620, is an airflow grid lug 622. Similarly, at each end of the grid branch 617 that is opposite the airflow grid extensions 618 is an airflow grid lug 622.

The airflow grid 604 allows for a measurement of airflow over a known surface area. In some examples, an airflow grid may also be known as an airflow measurement grid or air grid. In addition to airflow, the velocity of air movement across the airflow grid 604 may also be measured. These measurements can be conducted through an airflow grid measurement point(s) 624. In at least one example, each of the airflow grid extension(s) 618 and each of the grid branch(es) 617 can have an airflow grid measure point 624.

The airflow grid 604 may be positioned in proximity to a vent, duct (sometimes referenced as ductwork), or opening that is coupled to a fan. At the center of the airflow grid 604 is an airflow grid center point 620, and adjacent to the airflow grid center point 620 is the airflow coupling point 616 that allow for airflow measurements to be provided to an airflow sensor (not shown). The airflow coupling point(s) 616 allow for airflow to be received by the airflow grid measurement point(s) 624 and passed between the two airflow coupling point(s) 616. In some examples, there may be multiple measurement points along the airflow grid 604 that can be fluidly coupled to the airflow coupling point 616. In some embodiment, a set of airflow grids 604 may be utilized in conjunction with one another to measure across a large area of airflow that may be a plurality or a set of vents, ducts, or openings.

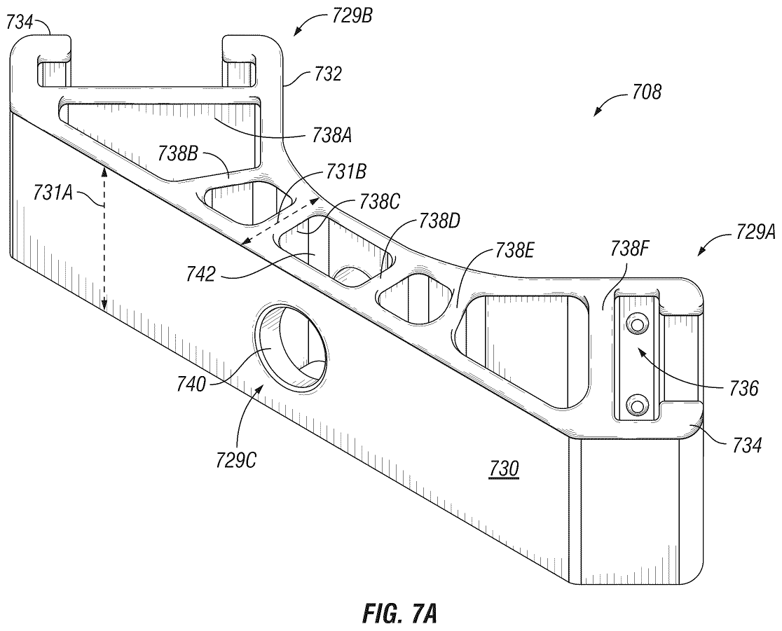

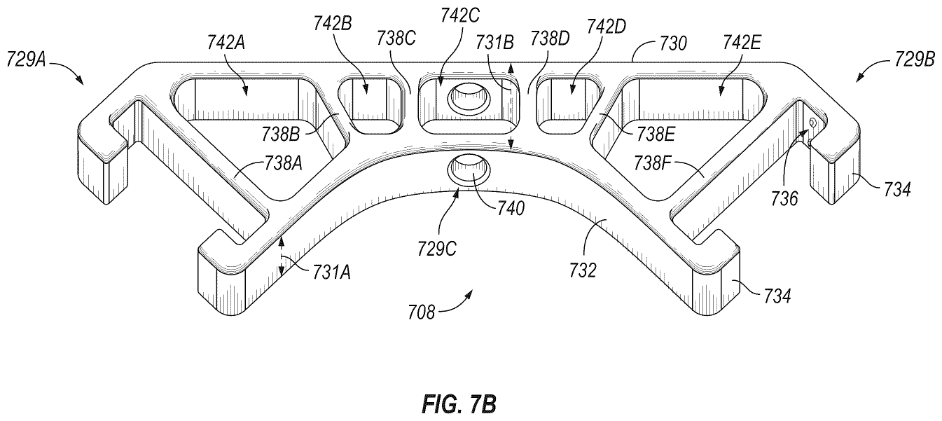

FIG. 7A is a rear perspective view illustration of a two-way connector 708. The two-way connector 708 is a trapezoidal shape that has a generally equally height 731A and depth 731B at its smallest point, though there are variations through the length of the two-way connector. There are multiple sections of the two-way connector 708, including but not limited to a first engagement section 729A, a second engagement section 729B, and a coupling section 729C. Where the engagement section 729A/729B allows for the two-way connector 708 to be coupled to an airflow grid (not shown) through lug engagement sections. The coupling section 729C allows for the two-way connector 708 to be coupled to a frame (not shown) or other structural elements, and also allows the two engagement sections 729A/729B to be connected together. The engagement sections 729A/729B may be placed a specified angle that allows the coupling of the two-way connector 708 to a set of airflow grids (not shown) in a manner that allows column and row structure.

The coupling section 729C can have a connector rear wall 730, and a connector front wall 732. Between these walls 730/732 is a set of supporting walls 738A/738B/738C/738D/738E//738F (collectively supporting walls 738) that also allow for a set of connector void(s) 742. The connector voids 742 allow for the two-way connector 708 to be light weight but also via the supporting wall(s) 738 provide support for the airflow grid(s). Through a center connector void 742 is a connector connection point 740 that passes through the center connector void 742, the connector rear wall 730, and the connector front wall 732. This connector connection point 740 allows for the two-way connector 708 to be coupled to a frame (not shown) via a fastener or fastener system. A fastener or fastener system can be a screw, bolt, nut, threaded mechanism, or other way to secure the two-way connector 708 with the frame (not shown).

The two-way connector 708 can have two engagement sections 729A/729B that are opposite one another along the length of the two-way connector 708. These engagement sections 729A or 729B, can be defined by a set of connector lips 734 and one of the supporting walls 738A or 738F. The distance between the supporting wall(s) 738A or 738F and the connector lips 734 allow for an airflow grid lug (not shown). The airflow grid lug (not shown) can be secured or engaged by a set of connector lug points 736. The connector lug point(s) 736 can be a rounded or angled point that extends from a wall or surface, and can engage with a void or aperture on the airflow grid lug (not shown).

FIG. 7B is a front perspective view illustration of a two-way connector. The two-way connector 708 is a trapezoidal shape that has a generally equally height 731A and depth 731B at its smallest point, though there are variations through the length of the two-way connector. There are multiple sections of the two-way connector 708, including but not limited to a first engagement section 729A, a second engagement section 729B, and a coupling section 729C. Where the engagement section 729A/729B allows for the two-way connector 708 to be coupled to an airflow grid (not shown). The coupling section 729C allows for the two-way connector 708 to be coupled to a frame (not shown) or other structural elements, and also allows the two engagement sections 729A/729B to be connected together. The engagement sections 729A/729B may be placed a specified angle that allows the coupling of the two-way connector 708 to a set of airflow grids (not shown) in a manner that allows column and row structure.

The coupling section 729C can have a connector rear wall 730, and a connector front wall 732. Between these walls 730/732 is a set of supporting walls 738A/738B/738C/738D/738E//738F (collectively supporting walls 738) that also allow for a set of connector void(s) 742A/742B/742C/742D/742E (collectively connector void 742). The connector voids 742 allow for the two-way connector 708 to be light weight but also via the supporting wall(s) 738 provide support for the airflow grid(s). Through a center connector void 742C is a connector connection point 740 that passes through the center connector void 742C, the connector rear wall 730, and the connector front wall 732. This connector connection point 740 allows for the two-way connector 708 to be coupled to a frame (not shown) via a fastener or fastener system. A fastener or fastener system can be a screw, bolt, nut, threaded mechanism, or other way to secure the two-way connector 708 with the frame (not shown). In some examples, the connector front wall 732 can be rounded or have radius that allows the engagement sections 729A/729B to be angled at a desired angle.

The two-way connector 708 can have two engagement sections 729A/729B that are opposite one another along the length of the two-way connector 708. These engagement sections 729A or 729B, can be defined by a set of connector lips 734 and one of the supporting walls 738A or 738F. The distance between the supporting wall(s) 738A or 738F and the connector lips 734 allow for an airflow grid lug (not shown). The airflow grid lug (not shown) can be secured or engaged by a set of connector lug points 736. The connector lug point(s) 736 can be a rounded or angled point that extends from a wall or surface, and can engage with a void or aperture on the airflow grid lug (not shown).

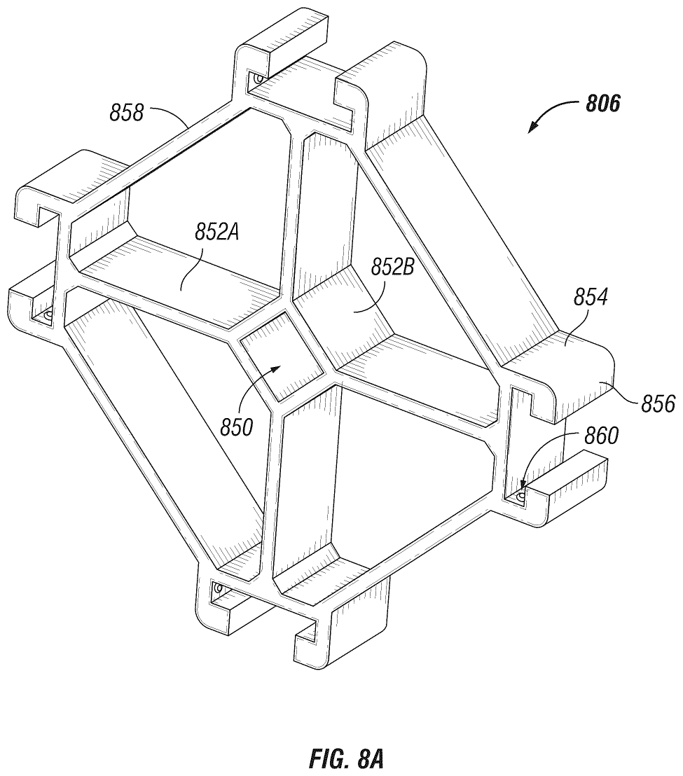

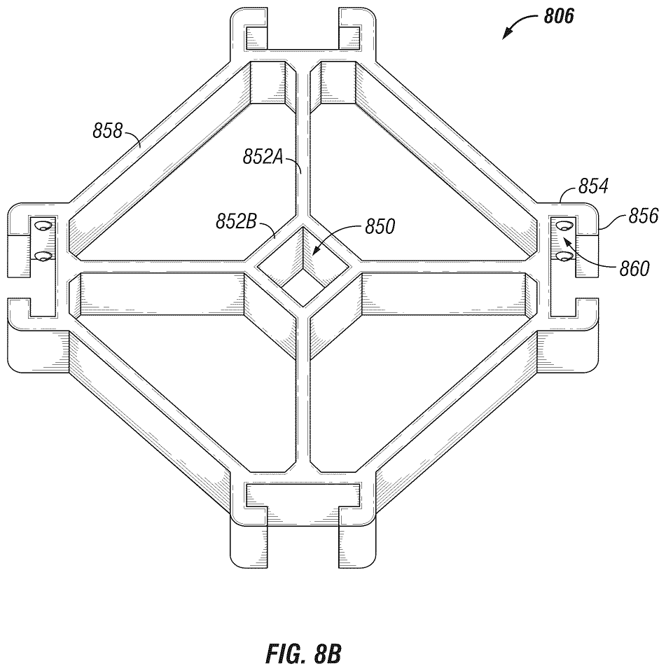

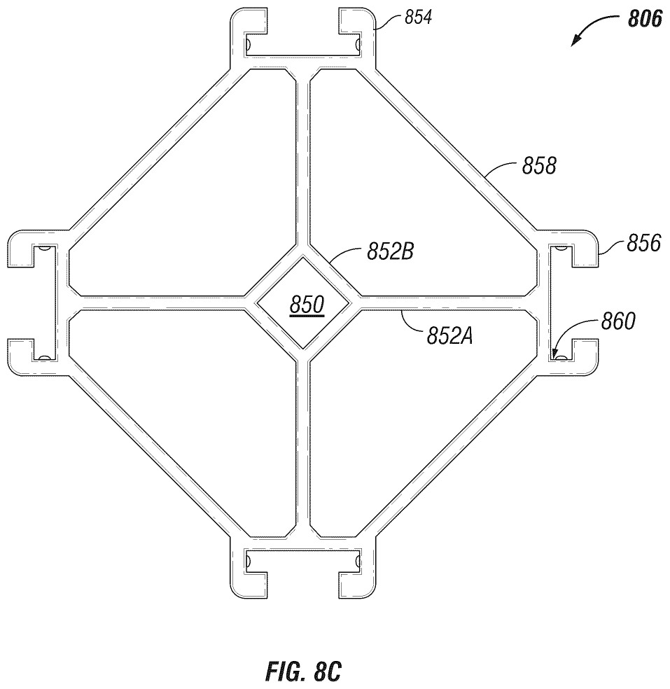

FIG. 8A is a side perspective view illustration of a four-way connector 806. The four-way connector 806 allows for the interconnection between airflow grids (not shown) when there are multiple airflow grids in a modular airflow sensor array. In at least one embodiment, the four-way connector 806 is generally square with outcroppings that allow for portions of an airflow grid (not shown) to be coupled to the four-way connector 806.

At the center of the four-way connector 806 is a connector center void 850 that is defined by a set of connector support braces 852A/852B. In at least one example, the connector center void 850 is defined by the connector support braces 852B, which are then coupled to a connector support braces 852A that extend outwardly. The connector support braces 852A can connect between the connector support braces 852B and the connector lug brackets 854. These structures allow for the four-way connector 806 to be lightweight, while also providing the necessary support to allow large supports arrays.

The connector lug brackets 854 can allow for a structure that can receive an airflow grid lug, or other support structure of an airflow grid (not shown). In at least one example, the connector lug brackets 854 are generally rectangular, with an opening along the longer side of the rectangle that faces outward from the center of the four-way connector 806. The opening along the longer side of the rectangle is defined by the connector lug lips 856. The connector lug lips 856 allow for the securing of an airflow grid lug (not shown) by wrapping around the airflow grid lug. In addition, to the connector lug lips 856 there is also the connector lug points 860 that can engage with the airflow grid (not shown). The connector lug points 860 can be rounded or other shape that extends from the inner surface of the connector lug bracket(s) 854 that allows for engagement with airflow grid lug (not shown). This type of engagement can allow for the connector lug point 860 to extend outwardly from the surface and be received by a void or aperture within airflow grid lug.

The connector lug bracket 854 can also be coupled to a set of connector outer support wall(s) 858 that can couple between each of the connector lug bracket(s) 854. The connector outer support wall 858 can allow for additional support that can prevent the connector lug bracket 854 from being moved. In at least one embodiment, the connector outer support wall 858 can be parallel to the connector support braces 852B.

FIG. 8B is bottom perspective view illustration of a four-way connector. The four-way connector 806 allows for the interconnection between airflow grids (not shown) when there are multiple airflow grids in a modular airflow sensor array. In at least one embodiment, the four-way connector 806 is generally square with outcroppings that allow for portions of an airflow grid (not shown) to be coupled to the four-way connector 806.

At the center of the four-way connector 806 is a connector center void 850 that is defined by a set of connector support braces 852A/852B. In at least one example, the connector center void 850 is defined by the connector support braces 852B, which are then coupled to a connector support braces 852A that extend outwardly. The connector support braces 852A can connect between the connector support braces 852B and the connector lug brackets 854. These structures allow for the four-way connector 806 to be lightweight, while also providing the necessary support to allow large supports arrays.

The connector lug brackets 854 can allow for a structure that can receive an airflow grid lug, or other support structure of an airflow grid (not shown). In at least one example, the connector lug brackets 854 are generally rectangular, with an opening along the longer side of the rectangle that faces outward from the center of the four-way connector 806. The opening along the longer side of the rectangle is defined by the connector lug lips 856. The connector lug lips 856 allow for the securing of an airflow grid lug (not shown) by wrapping around the airflow grid lug. In addition, to the connector lug lips 856 there is also the connector lug points 860 that can engage with the airflow grid (not shown). The connector lug points 860 can be rounded or other shape that extends from the inner surface of the connector lug bracket(s) 854 that allows for engagement with airflow grid lug (not shown). This type of engagement can allow for the connector lug point 860 to extend outwardly from the surface and be received by a void or aperture within airflow grid lug.

The connector lug bracket 854 can also be coupled to a set of connector outer support wall(s) 858 that can couple between each of the connector lug bracket(s) 854. The connector outer support wall 858 can allow for additional support that can prevent the connector lug bracket 854 from being moved. In at least one embodiment, the connector outer support wall 858 can be parallel to the connector support braces 852B.

FIG. 8C is a front view illustration of a four-way connector. The four-way connector 806 allows for the interconnection between airflow grids (not shown) when there are multiple airflow grids in a modular airflow sensor array. In at least one embodiment, the four-way connector 806 is generally square with outcroppings that allow for portions of an airflow grid (not shown) to be coupled to the four-way connector 806.

At the center of the four-way connector 806 is a connector center void 850 that is defined by a set of connector support braces 852A/852B. In at least one example, the connector center void 850 is defined by the connector support braces 852B, which are then coupled to a connector support braces 852A that extend outwardly. The connector support braces 852A can connect between the connector support braces 852B and the connector lug brackets 854. These structures allow for the four-way connector 806 to be lightweight, while also providing the necessary support to allow large supports arrays.

The connector lug brackets 854 can allow for a structure that can receive an airflow grid lug, or other support structure of an airflow grid (not shown). In at least one example, the connector lug brackets 854 are generally rectangular, with an opening along the longer side of the rectangle that faces outward from the center of the four-way connector 806. The opening along the longer side of the rectangle is defined by the connector lug lips 856. The connector lug lips 856 allow for the securing of an airflow grid lug (not shown) by wrapping around the airflow grid lug. In addition, to the connector lug lips 856 there is also the connector lug points 860 that can engage with the airflow grid (not shown). The connector lug points 860 can be rounded or other shape that extends from the inner surface of the connector lug bracket(s) 854 that allows for engagement with airflow grid lug (not shown). This type of engagement can allow for the connector lug point 860 to extend outwardly from the surface and be received by a void or aperture within airflow grid lug.

The connector lug bracket 854 can also be coupled to a set of connector outer support wall(s) 858 that can couple between each of the connector lug bracket(s) 854. The connector outer support wall 858 can allow for additional support that can prevent the connector lug bracket 854 from being moved. In at least one embodiment, the connector outer support wall 858 can be parallel to the connector support braces 852B.

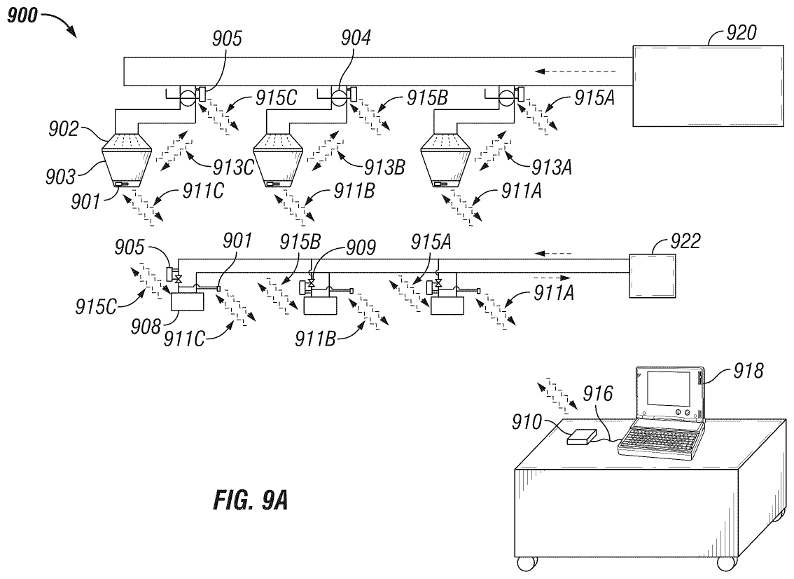

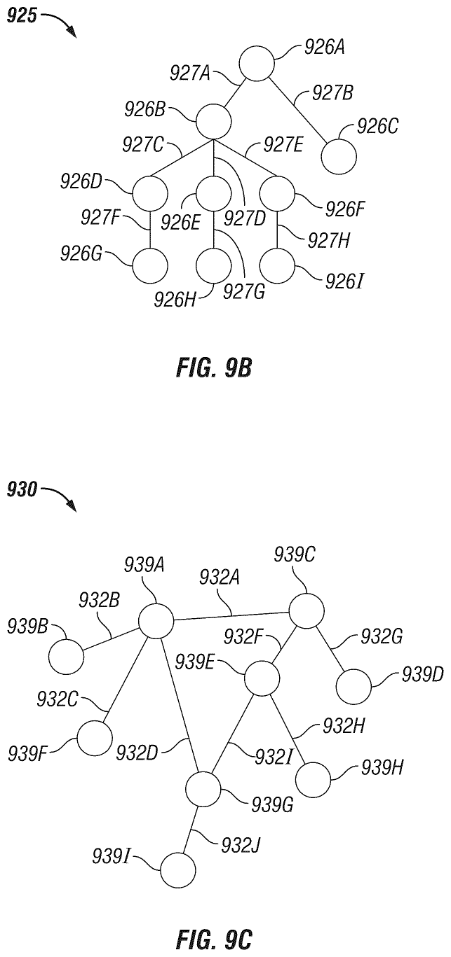

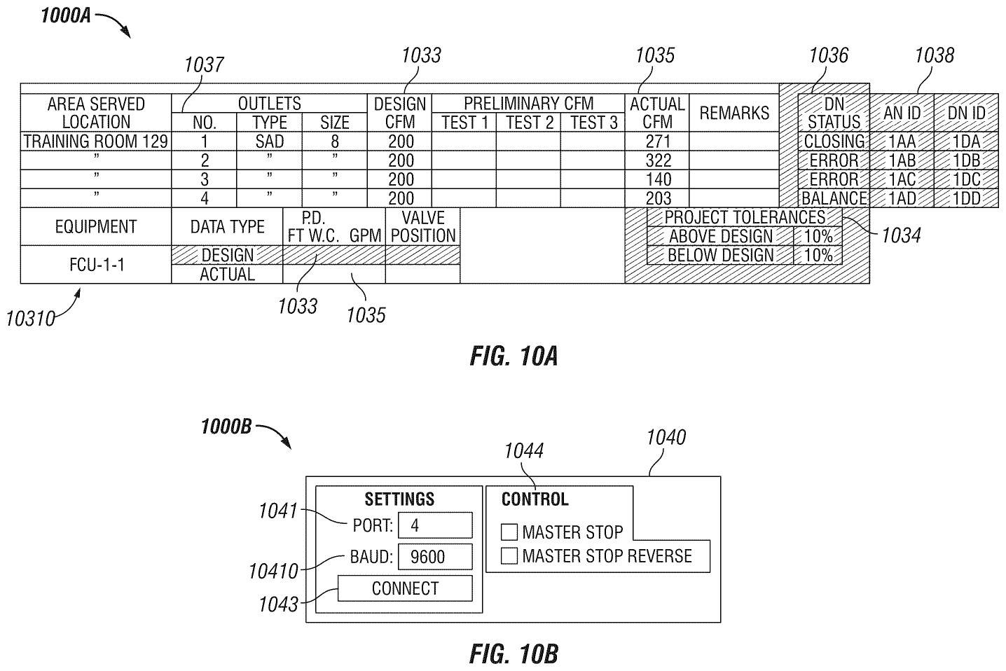

FIG. 9A illustrates a schematic HVAC airflow and water flow system and major components of the intelligent balancing system. FIG. 9B illustrates a tree schematic representation of network communication. FIG. 9C illustrates a mesh schematic representation of network communication.

FIGS. 9A, 9B, and 9C illustrate an HVAC airflow or water flow system 900 and the communication between a flow node 901, output node 905, and a base node 910. A base node is an assembly used to communicate inputs and outputs from multiple nodes and display related outputs on a computer. An output node is a compact wireless system that is used to open and close a damper or valve based on data feedback from other nodes, user feedback, or integrated sensors. A flow node is a compact wireless system that is used to sense air pressure or water pressure and communicate the data to other nodes. In some examples, the flow node may be a measurement device. The intelligent balancing system 900 is set up in a network configuration that allows many nodes to communicate over the distance of an HVAC system 920 or a water flow system 922. An HVAC system can mean a system that provides heat, ventilation or air conditioning to a building or a portion of a building.

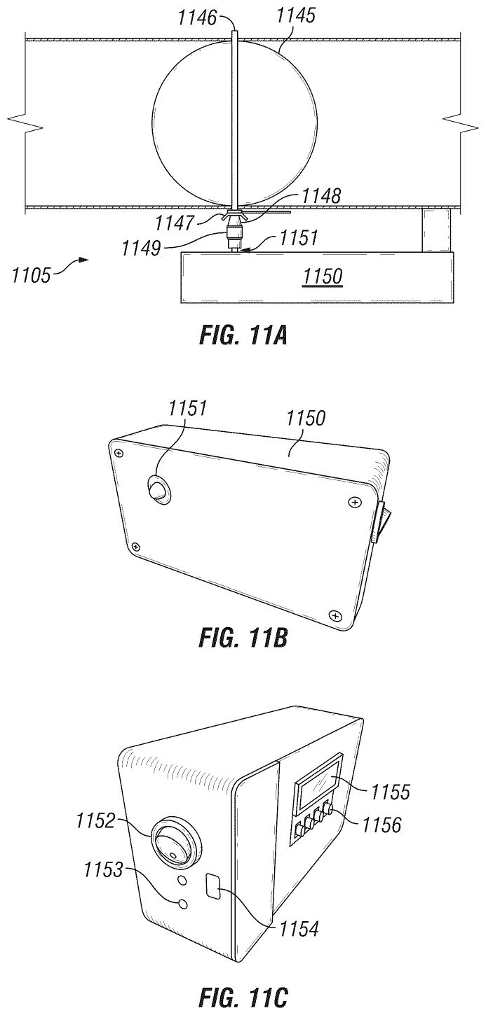

The base node 910 is the central hub of the system. The base node 910 is used to gather inputs and outputs from multiple sources such as the data user interface (seen in FIG. 10A), output nodes 905, and flow nodes 901. The base node 910 communicates inputs and outputs to their intended recipient. The output nodes can include control over a damper 904, or a control valve 909. In addition, there can be data or control aspects of a grille 902 or coil 908. A grille is a device that is connected to ductwork and distributes a volume of air in specific directions. A coil is a device that is connected to supply and return piping and transfers heat from one fluid to another. The flow nodes can also include the magnetic capture hood 903, that can, but is not limited to, connecting via a magnetic connection to the grille 902. A magnetic capture hood is a device used to channel airflow from a grille over a set surface area so a flow node can sense air pressure differential.

The base node 910 wirelessly communicates with output nodes 905, and flow nodes 901 through a communication interface such as, but not limited to, a wireless transceiver, or a radio frequency (RF) transceiver, which operates at or near a frequency of 2.4 GHz, or another suitable frequency that provides robust transmission for a line of sight and entirely or partially obstructed transmission condition. The base node 910 also may contain, but is not limited to a microprocessor, microcontroller, controller, or processor, or other similar computing devices. The base node 910 utilizes in a preferred embodiment, but is not limited to, a wired universal serial bus (USB) connection 916, connected to, but is not limited to, a computer or computing device 918. The computer or computing device 918, as well as other microprocessors, microcontrollers, controllers, or processors in the present disclosure may, but are not limited to, representing one or more microprocessors. The microprocessors may be “general purpose” microprocessors, or a combination of general and special purpose microprocessors. The computing device may also be but is not limited to a phone, smartphone, tablet, laptop, personal computer, or other similar computing devices. Additional specialized processing resources such as graphics, multimedia, or mathematical processing capabilities, either in hardware or in software, may also be used as adjuncts or replacements for processors for certain processing tasks. In addition, the computing device 918 as well as other microprocessors, microcontrollers, controllers, or processors in the present disclosure may also have, but are not limited to, having or be connected to memory, random access memory (“RAM”), a hard disc, non-volatile memory, a communication bus, a user interface, display, keyboard, mouse, trackpad, roller ball, and/or a power supply. Alternatively, the base node 910 may communicate to a hand-held device such as a smartphone or tablet. The base node 910 receives and sends data to and from a data user interface (seen in FIG. 10A) on the computing device 918, tablet, or smartphone utilizing, but not limited to, a serial communication protocol.

### Wireless Node Network

The wireless node network is the wireless protocol that the intelligent wireless test and balance system utilizes for node communication. The communications sent from the base node 910 can include flow node communications 911A, 911B, or 911C (collectively 911), flow to output node communications 913A, 913B, or 913C (collectively 913), and output node communications 915A, 915B, or 915C (collectively 915). These communications can include, but are not limited to, control signals, environment data, or flow data. The network topology may be tree 925 or mesh 930 depending on the node addressing requirements. Within a tree network 925, the nodes 926A-926I (collectively 926) communicate node to node (e.g., 926A communicates to 926B and 926C) through connections 927A-927I (collectively 927) to nodes 926 that are higher or lower in the tree hierarchy. However, in a mesh network 930, the nodes 131A-131I (collectively 931) communicate node to node (e.g., 931A communicates to 931B, 931F, 931G, and 931C) through connections 932A-932J (collectively 132) to nodes 931 across the network, but not limited to those in direct communication with the node allowing data to be relayed across the network. Each node in the network has a unique network address that allows for the identification of the node type, such as but not limited to output or flow nodes, and assignment of the node to a grille 902 number or coil 908 numbers. The base node 910 coordinates all incoming and outgoing messages, automatically, allowing the node network illustrated in FIG. 9A to interconnect itself, and for data to flow to and from nodes seamlessly.

FIG. 10A illustrates the data user interface. In FIG. 10A, the base node 910 shown in FIG. 9A (further references that are in range of 900-999 reference FIG. 9A, 9B, or 9C) communicates with the data user interface 1032, initially to acquire and store basic design data, such as, but not limited to, design flow 1033 values, and project tolerance 1034 percentages above and below design flow 1033 values, an illustrative example of which is seen as 1000A. The data user interface 1032 allows the user to provide initial system data, and to monitor actual node data and statuses in real time.

The base node 910 (shown in FIG. 9A) sends and receives different types of data messages from other nodes automatically. When the base node receives a message, the base node checks to see if the node it received the message from is on the active node list and if it is not the base node adds the node to the list. A “T” message is received from a flow node 901 (shown in FIG. 9A) and contains the actual flow value 1035 that corresponds to the damper or valve address of the flow node. A damper is a device that controls the volume of airflow through ductwork. The device may be infinitely adjustable through manual human manipulation between two extreme states such as fully open or fully closed. An “S” message is received from an output node 905 (shown in FIG. 9A) and contains the output node status 1036, such as opening, closing, or balanced. An “R” message is received from an output node and contains a request for design flow value 1033, resulting in a “D” message being sent back in response that includes the design flow value 1033. A design flow value is a volumetric measurement of airflow or water flow an HVAC design engineer specifies that meets the needs of the indoor space.

A computer or base node computing device 918 (shown in FIG. 9A) is utilized to display a data user interface 1032 that contains one or more matrices containing airflow or water flow data such as HVAC design flow values 1033, actual flow values 1035, and output node status 1036. A user may at an earlier time populate the data user interface 1032 with individual HVAC system data such as area served location, sequence number 1037, neck size, volumetric airflow rates, volumetric water flow rates, and project tolerances 1034 above and below the specified volumetric flow rate allowed by design. Each matrix row is used to correlate input and output data with a grille or coil sequence number 1037 and output node 905 and flow node 901 pair sequence. Additional data may be available to the user, such as output node status 1036, and unique node identification code 1038. The data user interface 1032 is not limited to running on the base node computing device 918 (seen in FIG. 9A) and may exist on a smart device such as or similar to an Android or iOS device, of which may be handheld, worn on the body, or utilize a heads-up display.

FIG. 10B illustrates the base node interface. In FIG. 10B an illustrative example (1000B) of the base node interface is provided. The base node interface 1040 allows the user to connect the base node 910 (shown in FIG. 9A further references that are in range of 900-999 reference FIG. 9A, 9B, or 9C) and the data user interface 1032 (shown in FIG. 10A) and to send master commands.

The base node interface 1040 allows the user to specify the initial communication settings such as, but not limited to, serial port channels 1041, baud rates 1042 at which a channel transfers data over the channel unique to the base node 910 (shown in FIG. 9A). The user can use an interface button 1043 to connect or disconnect the base node 910 (shown in FIG. 9A), as well as send master control commands 1044. The base node 910 (shown in FIG. 9A) interface 1040 can be, but is not limited to, a plug-in for Microsoft Excel, or other spreadsheet, mathematical, or programmable software package, that can allow for direct integration with the data user interface 1032. Additionally, the base node interface 1040 is not limited to running on the computing device 918 (seen in FIG. 9A) and may exist on a smart device such as or similar to an Android or iOS device, of which may be handheld, worn on the body, or utilize a heads-up display.

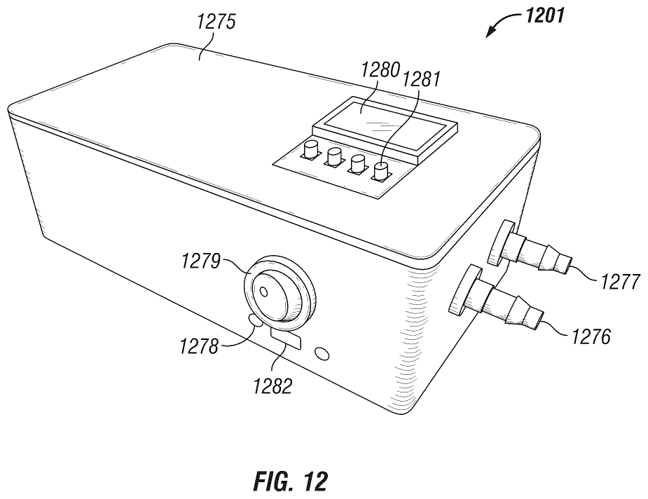

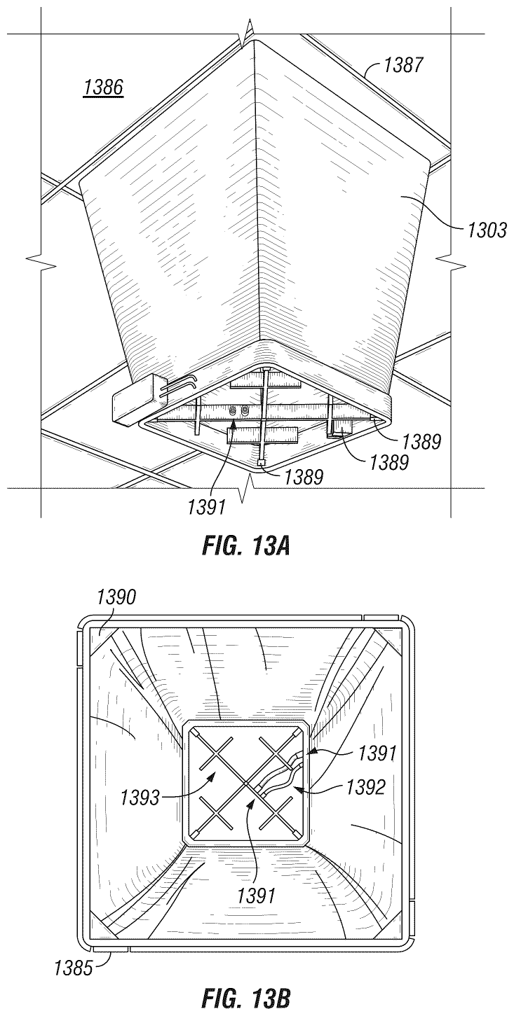

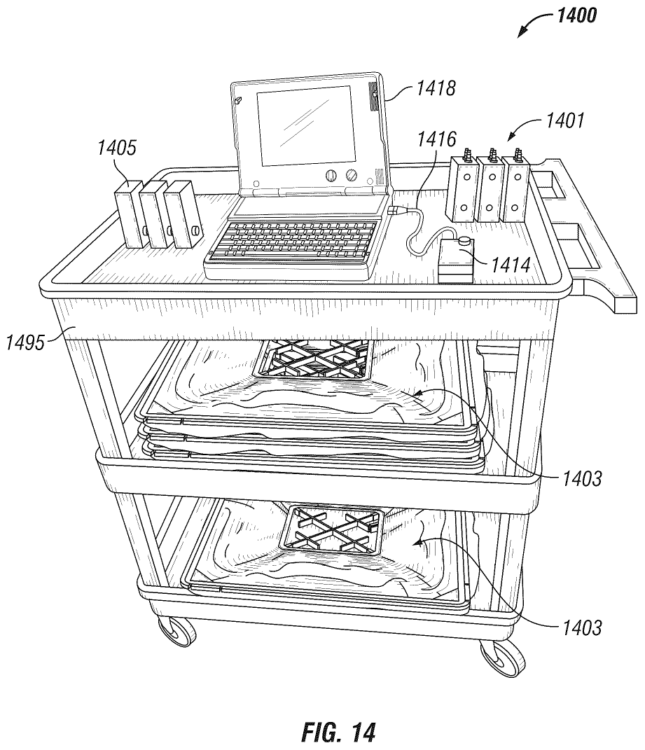

FIG. 11A illustrates the output node with a schematic diagram of a typical HVAC damper or valve and ductwork or pipe layout. FIG. 11B illustrates an alternative view of the output node enclosure. FIG. 11C illustrates an alternative view of the output node enclosure.

In FIGS. 11A, 11B, and 11C, the output node assembly is illustrated. The output node assembly 1105 is a compact wireless system that is used to open and close a damper 904 or valve 909 (shown in FIG. 9A) based on, but not limited to, data feedback from other nodes, user feedback, or integrated sensors. Additional references to numerals in the 900-999 refer to FIG. 9A, 9B, or 9C, and references to numerals in the 1000-1099 refer to FIG. 10A or 10B.

The output node 1105 utilizes an output node wireless transceiver such as, but not limited to, a radio frequency transceiver similar to that of the base node 910 (shown in FIG. 9A) that is connected to the output computing device. Other wireless transmission standards can also be utilized, such as but not limited to LoRa, LoRaWAN, Wi-Fi, Bluetooth, ZigBee, Near Field Communication (“NFC”), 5 GHz, and/or cellular communications system, such as, but not limited to, LTE. Utilizing the RF transceiver, the output node 1105 may include, but is not limited to, the ability to transmit or receive data from other output nodes 1105, flow nodes 901, and the base node 910 (shown in FIG. 9A) simultaneously or at once. Data transmitted or received may be, but is not limited to, a design flow value 1033, actual flow 1035 value, or output node status 1036 (shown in FIG. 10A). Any data transmitted or received may be stored on a data storage medium such as, but not limited to memory, a memory card, or a hard disc drive.

An electric gear motor or similar motor (not shown) with characteristics such as, but not limited to low revolutions per minute and high torque to size ratio is, placed within the enclosure 1150, and used to rotate the damper or valve shaft 1146. An electric motor control circuit can, but is not limited to, varying speed, duration, and direction of rotation through varying techniques such as, but not limited to, pulse width modulation. In a preferred embodiment, a motor control circuit is placed within the enclosure 1150, and is connected to a processor, controller, microprocessor, or micro-controller circuit such as, but not limited to, the same processor, controller, microprocessor, or micro-controller circuit or output computing device that operates the wireless or wired system.

The torque of the electric motor can be measured by, but is not limited to, a current sensing circuit as current draw is related to the amount of torque the electric motor is applying to the valve or damper shaft 1146. In a preferred embodiment of the present disclosure, the output node 1105 utilizes a current circuit so that if damper or valve blades 1145 are bound, stuck, or are constrained by rotation stops they will not break as a result of applying too much torque. A maximum current threshold can be set, via the base node computing device, output node computing device, processor, controller, microprocessor, or micro-controller circuit, or through a message from the data user interface (shown in FIG. 10A) for the electric motor not to exceed the threshold. If the motor exceeds the threshold, it is stopped, preventing any damage from occurring to the damper or valve and the output node 1105 can, for example but is not limited to, communicating an output node status 1036 (seen in FIG. 10A) error back to the data user interface 1032.

The output node 1105 uses a rigid compact enclosure 1150 that is designed to house components of the output node 1105 while allowing the electric motor shaft 1151 to pass through the enclosure 1150. The enclosure 1150 is made of a durable material, such as, but not limited to, acrylonitrile butadiene styrene (ABS) plastic, providing durability, impact resistance, and minimal impact on 2.4 GHz radio waves, other materials of manufacture could include but are not limited to wood, metal, plastics, carbon fiber, polyvinyl chloride, or other composite materials. The enclosure 1150 may also include, but is not limited to having, an on and off power switch 1152, viewing accesses for light emitting diode (LED) indicators 1153, and/or a charging port 1154. The user may interface with the output node 1105 through an incorporated liquid crystal display (LCD) 1155 and directional buttons 1156, allowing the user to visually monitor the status of the output node 1105, as well as provide node specific inputs as needed, such as, but not limited to, output node identification 1038. The LED indicators, charging port, battery, display, or buttons may be connected to the output node computing device.

The output node 1105 can contain, but is not limited to, a rechargeable lithium-ion battery or other power source that is sized to deliver the required energy to power the output node 1105 for one or more typical days of testing and balancing. Additionally, other power sources could be alternative power sources such as, but not limited to, Alternative Current (“AC”), Direct Current (“DC”), solar power, wind power, or power generated by moving water. The output node 1105 contains a circuit designed to allow the user to recharge the battery or connect other power sources utilizing, but not limited to, a USB cable and the charging port 1154. LED indicators 1153 are used, but not limited to, communicating battery level or charging status, and a “low battery” status can be made available to the user on, but not limited to, the LCD screen 1155 or remotely on the data user interface 1032 (shown in FIG. 10A).

When powered on, the output node 1105 is designed to monitor specific start-up criteria before the electric motor is engaged. The output node 1105 must initially receive at least one of, but not limited to: (a) a valid design flow value 1033 from the base node 910, (b) a valid actual flow value 1035 from the paired flow node 901, and/or (c) have not received a master stop command 1044 from the base node 910. Once the initial startup criteria have been met the output node 1105 transitions into a setup phase, and the output node 1105 stores the actual flow value 1035 at that moment as a baseline value before rotating the damper or valve shaft 1146 with the output node 1105 electric motor. The electric motor is engaged to rotate the damper or valve blade 1145 in a known direction, such as but not limited to a clockwise rotation, while the output node 1105 monitors the resulting change in actual flow value 1035 from the paired child flow node 901. While rotating, the output node 1105 evaluates the absolute value of the difference between the current flow, and the initial baseline flow against a set difference amount that corresponds with the consistent correlation between rotational direction and flow values corresponding to the damper or valve blade 1145 opening or closing. If the difference value is met or exceeded, the signed difference value is used to assign a clockwise or counterclockwise rotation, a positive difference is related to opening, and a negative difference is related to closing.

During the setup phase, while the electric motor is rotating, the motor current is monitored. A current value greater than a set maximum threshold stops the electric motor from rotating in its present direction and results in beginning the setup phase over in the opposite direction. If the maximum threshold current is exceeded again after, having switched directions, the motor stops and an error status is sent to display on the data user interface 1032 (shown in FIG. 10A). The output node 1105 completes the setup phase once the rotation is assigned or the setup phase exceeds a preset maximum duration of time, which if exceeded, stops rotation and assigns rotation based on the difference value at that point.

Once the startup and setup phases are complete, the output node 1105 operates in the balancing phase. The balancing phase utilizes the set project tolerance 1034 percentages above and below design flow value 1033 as the target range, which represents a balanced state. Balanced state is the condition when the current actual flow 1035 value from the paired flow node 901 is within the range of the set project tolerances 1034 percentages. Based on the actual flow 1035 value from a paired flow node 901, the paired output node motor is energized and rotated in the direction that results in the actual flow 1035 value converging on the balanced state range. The output node 1105 stores a new time value in milliseconds each time it receives a new actual flow 1035 value from the paired flow node 901 and each time the output motor energizes, the output node 1105 stores a time value in milliseconds, but is not limited to storing a time value in milliseconds, as other time intervals such as microsecond or nanoseconds may also be used. The output node 1105 subtracts the two stored time values to monitor the electric motor run time between receiving actual flow 1035 values. A set maximum duration runtime threshold is used to compare to the runtime duration of the electric motor. If the motor exceeds the runtime duration, the motor stops and the output node 1105, sends a time-out output node status 1036 back to the base node 910 for display on the data user interface 1032. Output node 1105 constantly monitors the motor current to compare to a preset maximum current threshold during the balance phase. If the motor exceeds the threshold, the output motor stops, and an error output node status 1036 is sent to the base node 910 to display on the data user interface 1032. Master commands 1044 sent from the base node 910 can control output nodes 1105 and a master stop command can disable motor movement regardless of flow node 901 input. The output node 1105 cannot move until the output node 1105 receives a command removing the master stop command or the output node 1105 power is cycled off and on.

### Output Motor Socket

The output motor socket 1149 adapts between the output motor shaft 1151 and the shaft adapter 1148. The shaft adapter 1148 can then nest within the outward angled wings of a standardly installed wing nut 1147 or to allow tool access to the damper or valve shaft 1146. The output motor transmits rotational force through the output motor shaft 1151, traditionally the output motor shaft will be, but not limited to, a round output shaft that has a section notched to provide a key slot.

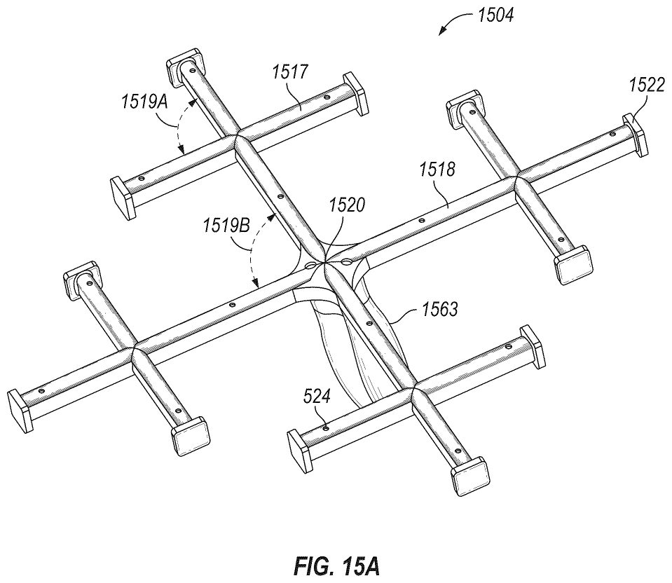

FIG. 12 illustrates the flow node 1201. The flow node 1201 is a compact wireless system that is used to sense and communicate the differential pressure of airflow through the magnetic capture hood (not shown) or water flow rates through a coil (not shown). A flow node 1201 can be configured for airflow measurement and is represented by airflow node and/enclosure 1275.

The airflow node 1275 utilizes but is not limited to, a compact and ultra-low range differential pressure sensor (not shown) with high accuracy and precision, especially near zero pressure and enclosed within the airflow node enclosure 1275. The sensor has, but is not limited to, a digital output and communicates through, but is not limited to, the inter-integrated circuit (I2C) protocol, and the sensor incorporates, but is not limited to the incorporation of, calibration, temperature compensation, and signal linearization into the data output. The sensor measures differential pressure by a thermal sensor element using flow-through technology. Compared with membrane-based sensors, typically used by most pressure sensors for HVAC test and balance measurement, the flow-through technology does not require constant recalibration with air valves and experiences no offset drift. The sensor used contains, but is not limited to, a thermal mass flow sensor element, amplifier, analog to digital (A/D) converter, EEPROM memory, digital signal processing circuitry and interface. In addition, the sensor measurement range is specifically matched to typical max actual airflow value the sensor is intended to measure from a grille (not shown).

A flow node 801 designed for measurement of water flow can utilize a compact differential pressure sensor rated for liquid measurement with high accuracy and precision. The sensor measurement range is specifically matched to typical max actual water flow value the sensor is intended to measure from a coil (not shown).

The flow node 1201 uses a small microprocessor, but is not limited to a flow node computing device, micro-controller, processor, or controller as well, to receive the digital output of a flow node 1201 sensor. The microprocessor or flow node processor or flow node computing device is used to store multiple readings and average the result, on a data storage medium such as, but not limited to memory, a memory card, or a hard disc drive. The flow node 1201 converts the averaged result from pressure units, typically inches water column for air or pounds per square inch for water, to feet per minute (FPM) for air and gallons per minute (GPM) for water with industry standard conversion formulas. For air measurement, further converting FPM to a cubic foot per minute (CFM) result is done by multiplying the FPM result by the unobstructed measurement surface area perpendicular to the flow inside of the magnetic capture hood (not shown). After conversion, the flow node 1201 reading units are the same as the design flow (seen in FIG. 10A) value specified by the design engineer.

The flow node 1201 utilizes a flow node wireless transceiver such as a radio frequency transceiver similar to that of the base node (seen in FIG. 9A). The flow node transceiver may be connected to the flow node computing device. Utilizing the RF transceiver, the flow node 1201 may include, but is not limited to, the ability to transmit data from other flow nodes 1201, output nodes (seen in FIG. 9A), and the base node simultaneously or at once. Data transmitted or received may be, but is not limited to, the form of actual flow values, design flow values, and master control commands (shown in FIGS. 10A and 10B).

The flow node 1201 uses a rigid compact enclosure 1275 which is designed to house all flow node 1201 components while allowing the sensor positive 1276 and negative pressure ports 1277 to pass through the enclosure 1275. The enclosure 1275 is made of durable material, such as, but not limited to, acrylonitrile butadiene styrene (ABS) plastic, providing durability, impact resistance, and minimal impact on 2.4 GHz radio waves, other materials of manufacture could include but are not limited to, wood, metal, plastics, carbon fiber, polyvinyl chloride, or other composite materials. The enclosure 1275 may have, but is not limited to having, an on and off power switch 1279, viewing access for light emitting diode (LED) indicators 1278, and a charging port 1282.

The user may interface with the flow node 1201 through, but not limited to, an incorporated liquid crystal display (LCD) 1280 and directional buttons 1281. The LCD 1280 and directional buttons 1281 allow the user to visually monitor the actual flow (shown in FIG. 10A) sensed by the flow node 1201, as well as provide node specific inputs as needed, such as a unique node identification code (shown in FIGS. 10A and 10B).

The flow node 1201 can contain, but is not limited to, a rechargeable lithium-ion battery that is sized to provide the required energy to power the flow node 1201 for one or more typical days of testing and balancing. Additionally, other power sources could be alternative power sources such as, but not limited to, Alternative Current (“AC”), Direct Current (“DC”), solar power, wind power, or power generated by moving water. The flow node 1201 can contain, but is not limited to, a circuit designed to allow the user to recharge the battery utilizing a USB cable and the charging port 1282. LED indicators 1278 are used, but not limited to the uses, of communicating the battery level or charging status. In addition, a “low battery” status can be made available to the user on, but not limited to, the LCD 1280 screen or remotely on the data user interface (shown in FIG. 10A). The flow node computing device may be connected to the battery, LED indicators, charging port, display, or buttons of the flow node.

The flow node 1201 processes pressure readings and sends and receives different types of data messages from other nodes automatically. An “N” message is received from the base node (shown in FIG. 9A) and contains a list of active nodes. A “T” message is sent from the flow node 1201 to the base node and its corresponding output node (shown in FIG. 9A) and contains the actual flow value. The flow node 1201 specific to airflow measurement secures onto the magnetic capture hood (not shown) in a location that allows for the pressure ports 1276/1277 to be attached to the magnetic capture hood.

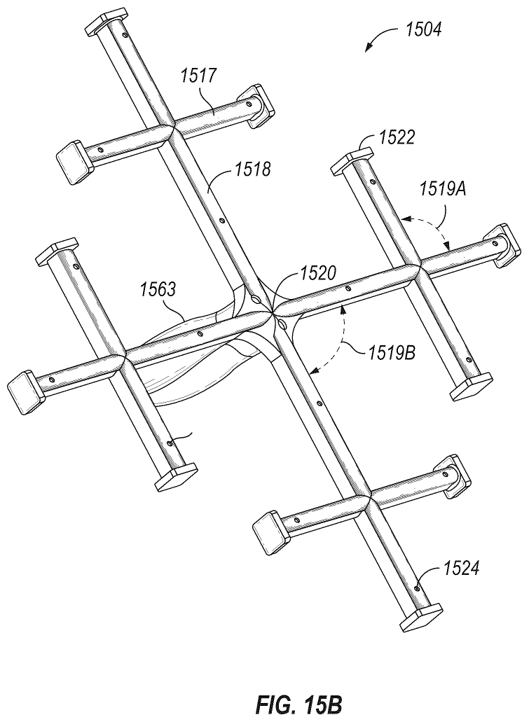

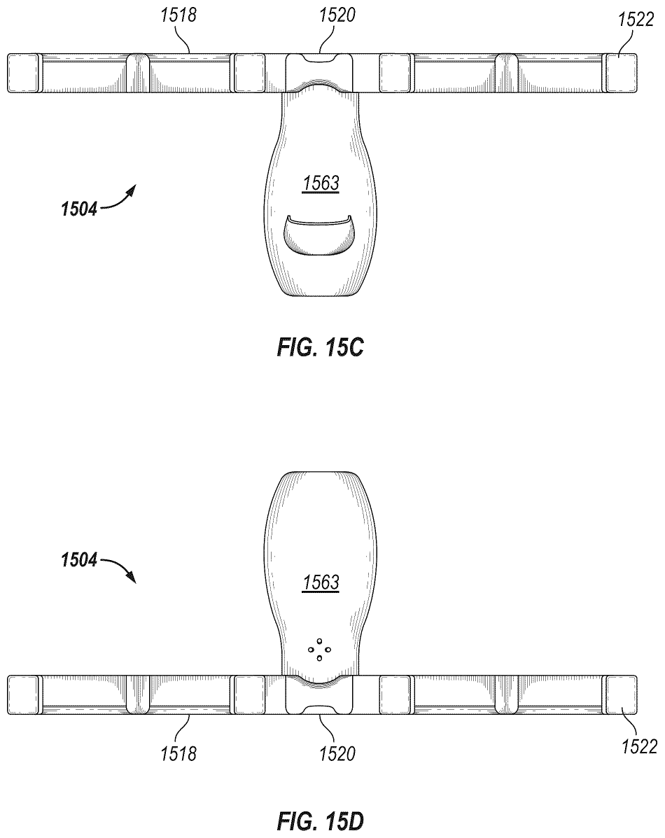

FIG. 13A illustrates the flow node attached to the magnetic capture hood 1303. FIG. 13B illustrates the magnetic capture hood 1303. The magnetic capture hood 1303 illustrated in FIGS. 13A and 13B, is used to gather airflow from a grille (shown FIG. 9A) for measurement, or alternatively act as a flow detection module. The flow detection module 1393 may also contain the flow node sensor. The flow detection module 1393 may also include alternative designs such as circle, square, triangle or other polygon shapes. The pressure ports seen in FIG. 12 as 1276 and 1277 can be connected to the flow detection module or flow node sensor through ports 1391 or hoses 1392. It would be understood that in alternative embodiments of the present disclosure the port or hoses maybe utilized in tandem or individually based upon the design of the flow node, flow node sensor or flow detection module. The magnetic capture hood 1303 is customized to allow a single user to deploy multiple magnetic capture hoods 1303 and utilize them simultaneously during the testing and balancing process. The magnetic capture hood 1303 is also sized to hold the flow detection module 1393.

Airflow capture hoods similar to those produced by Shortridge Instruments, Inc. or Evergreen Telemetry are commonly utilized throughout the testing and balancing industry. Most capture hoods used in the industry are large and are held against a grille by hand or with a pole from the bottom, requiring a rigid internal structure to hold them open during testing. The size constraint leads to difficulties in areas such as transport, use in tight spaces and increased setup time.

The magnetic capture hood 1303 utilizes magnets 1385 at the top of the frame 1390 in the area that comes in contact with the ceiling grid 1387. A vast majority of ceiling grids 1387 are ferrous metal allowing the magnet 1385 to stick to the ceiling grid 1387 surfaces. The magnetic capture hood 1303 suspends itself from the ceiling 1386 with the magnets 1385, and the weight of the bottom 1389 of the magnetic capture hood 1303 holds it open. The use of gravity allows for the removal of internal structures from the magnetic capture hood 1303.

The use of magnets 1385 and gravity to hold and extend the magnetic capture hood 903 provide a unique advantage, allowing one user to quickly deploy multiple magnetic capture hoods 903 simultaneously during the testing and balancing process.

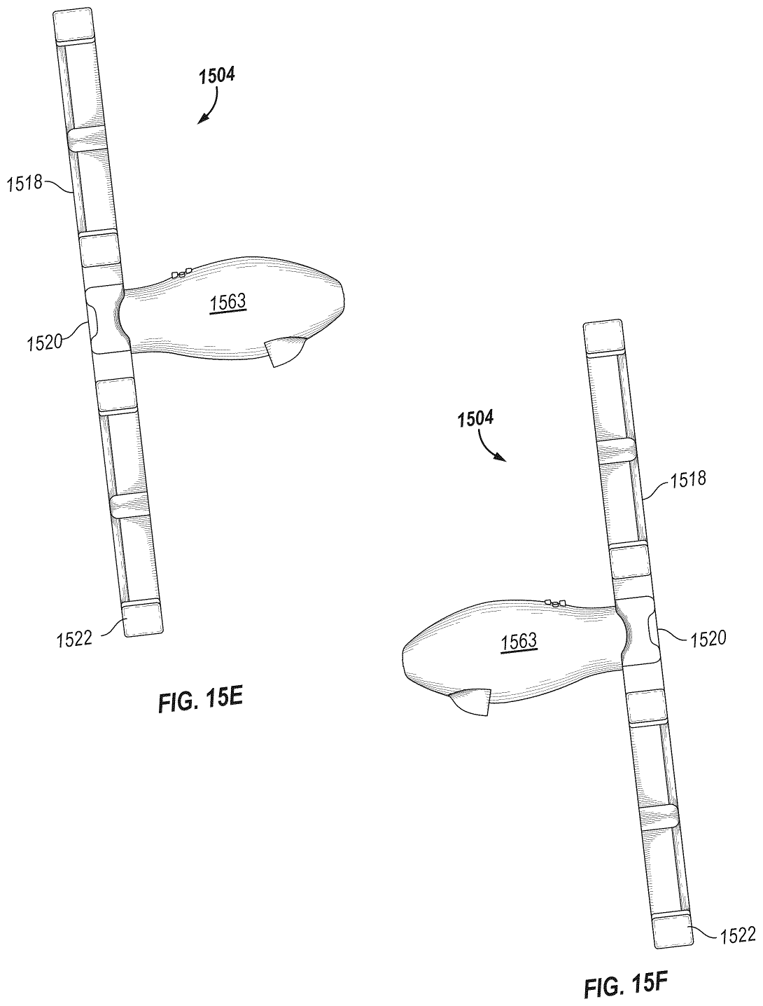

FIG. 14 illustrates the utility cart 1495 is used to store, transport, and charge the intelligent wireless test and balance system 1400. The intelligent wireless test and balance system is stored and transported on the utility cart 1495 illustrated in FIG. 14. The utility cart 1495 stores many nodes, such as but not limited to, flow nodes 1401 or output noes 1405 and can serve as a charging station with integrated battery power, multiple charging cords or wireless charging capabilities. The utility cart 1495 also stores multiple magnetic capture hoods 1403 due to their collapsible design. Additionally, the utility cart 1495 can also provide a user a station to work from that includes a computer 1418, connection cord 1416 and base node 1410 to communicate with all the various nodes, such as but not limited to, flow nodes 1001 or output noes 1405 that are deployed. The utility cart may be self-powered including the ability to transport the user as well as the intelligent wireless test and balance system.

The present disclosure may include a computing device that can include any of an application specific integrated circuit (ASIC), a microprocessor, a microcontroller, a digital signal processor (DSP), a field-programmable gate array (FPGA), or equivalent discrete or integrated logic circuitry. In some examples, the system may include multiple components, such as any combination of one or more microprocessors, one or more microcontrollers, one or more DSPs, one or more ASICs, or one or more FPGAs. It would also be understood that multiples of the circuits, processors, or controllers could be used in combination or in tandem, or multithreading. Additionally, it would be understood that a browser or program could be implemented on a mobile device or mobile computing device, such as, a phone, a mobile phone, a cell phone, a tablet, a laptop, a mobile computer, a personal digital assistant (“PDA”), a processor, a microprocessor, a micro controller, or other devices or electronic systems capable of connecting to a user interface and/or display system. A mobile computing device or mobile device may also operate on or in the same manner as the computing device disclosed herein or be based on improvements thereof.

The components of the present disclosure may include any discrete and/or integrated electronic circuit components that implement analog and/or digital circuits capable of producing the functions attributed to the modules herein. For example, the components may include analog circuits, e.g., amplification circuits, filtering circuits, and/or other signal conditioning circuits. The components may also include digital circuits, e.g., combinational or sequential logic circuits, memory devices, etc. Furthermore, the modules may comprise memory that may include computer-readable instructions that, when executed cause the modules to perform various functions attributed to the modules herein.

Memory may include any volatile, non-volatile, magnetic, or electrical media, such as a random-access memory (RAM), dynamic random-access memory (DRAM), static random-access memory (SRAM), read-only memory (ROM), non-volatile RAM (NVRAM), electrically-erasable programmable ROM (EEPROM), flash memory, hard disks, or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, or any other number of possible drives or discs, that are executed by the internal logic of a computing device. It would be understood that the tangible non-transitory computer readable medium could also be considered a form of memory or storage media.

FIGS. 9A-14 are illustrations of a measurement system for a single airflow grid. When then airflow grid is utilized across an array of measurement systems, there can be measurements made for multiple dampers or grille across an. The node system can allow for multiple dampers or grilles to be adjusted across an entire measurement array.

FIG. 15A is a right side perspective view of a modular multi-chamber airflow grid 1504. FIG. 15B is a left side perspective view of a modular multi-chamber airflow grid 1504. FIG. 15C is a top view of a modular multi-chamber airflow grid 1504. FIG. 5D is a bottom view of a modular multi-chamber airflow grid 1504. FIG. 15E is a right side view of a modular multi-chamber airflow grid 1504. FIG. 15F is a left side view of a modular multi-chamber airflow grid 1504. FIG. 15G is a front view of a modular multi-chamber airflow grid 1504. With respect to FIGS. 15A-15G are illustrations of a modular multi-chamber airflow grid 1504 (maybe also be referenced as an airflow grid 1504), which can be used to make airflow and related measurements. The modular multi-chamber airflow grid 1504 is a modular velocity grid with a self-contained differential pressure sensor and/or temperature and/or humidity sensor and supporting electronics to take environmental sensor readings, perform calculations, wirelessly communicate data bi-directionally to a computing device. Additionally, a modular multi-chamber airflow grid 1504 can communicate with its user through visual and/or audible cues that allow the user to make system adjustments based on this feedback. Multiple modular multi-chamber airflow grid 1504 can be combined in a modular fashion to create a modular airflow sensor array. An example of visual cues would be utilizing a light emitting diode (LED) to flash a pattern and/or specific color if telemetry is within a desired range or above or below a threshold.

A modular multi-chamber airflow grid 1504 can include two chambers, a chamber A and a chamber B. Chamber A and chamber B do not connect and are separate, which allows for them to provide a differential pressure. The rigid embedded differential pressure sensor has two separate air pressure ports. One port is connected to chamber A and one port is connected to chamber B. Each port is separate and not connected to the other. The connection between the pressure sensor and the pressure chambers is rigid and embedded and does not require tubing. The rigid attached node on the velocity grid can contain a MCU, environmental sensors, LED's, wireless communication, power source, and supporting electronics.

The modular multi-chamber airflow grid 1504 can include a sensor pod 1563 that allows for the airflow sensors, pressure sensors, differential pressure sensor, and other environmental sensors to be housed within the airflow grid 1504. The airflow grid 1504 can have an airflow grid center point 1520 that allows for airflow grid extensions 1518 to extend from it. While the airflow grid extensions 1518 are shown at right angles (or ninety (90) degrees) 1519A/1519B from each other, other angles may be used for more or fewer extensions. It would be understood that other angles can include but are not limited to 15, 30, 45, 60, 75, 90, 105, 120, 135, 150, 165, or 180 degrees. In at least one embodiment, there can be four airflow grid extensions(s) 1518, where each of the extensions are set ninety (90) degrees from each other. Meaning that the first extension is at 0 degrees, the second extension is at 90 degrees, the third extension is at 180 degrees, and the fourth extension is at 270 degrees.

At the end of the airflow grid extension(s) 1518 can be an airflow grid lug 1522 (may be referenced as a lug or grid lug). The airflow grid lug 1522 allows the airflow grid 1504 to be engaged or coupled to a set of connectors, such as but not limited to, the four-way connector or the two-way connector. In at least one embodiment, the airflow grid 1504 can have four airflow grid extensions 1518 and each airflow grid extension 1518 can have a grid branches 1517. As shown these grid branches 1517 are set at 90 degrees from each of the airflow grid extension 1518. In the present disclosure, there can be a first grid branch 1517 opposite a second grid branch, where the grid branch(es) 1517 are perpendicular to the airflow grid extensions 1518. When the grid branch(es) 1517 are perpendicular to the airflow grid extensions they may be referenced or called a cross member. While grid branch(es) 1517 are shown set at 90 degrees from each of the airflow grid extensions 1518, it would be understood that they could be placed at any angle from 0 to 180 degrees. It would be understood that other angles can include but are not limited to 15, 30, 45, 60, 75, 90, 105, 120, 135, 150, 165, or 180 degrees. In the present disclosure, there can be a first grid branch 1517 opposite a second grid branch, where the grid branch(es) 1517 are perpendicular to the airflow grid extensions 1518. This means that a first grid branch at 90 degrees to the airflow grid extension 1518, and then a second grid branch is at 180 degrees from the first grid branch, and 270 degrees from the airflow grid extensions.

The airflow grid 1504 allows for a measurement of airflow over a known surface area. In some examples, an airflow grid may also be known as an airflow measurement grid or air grid. In addition to airflow, the velocity of air movement across the airflow grid 1504 may also be measured. These measurements can be conducted through an airflow grid measurement point(s) 1524. In at least one example, each of the airflow grid extension(s) 1518 and each of the grid branch(es) 1517 can have an airflow grid measure point 1524. At the end of each airflow grid extension 1518 that is opposite the airflow grid center point 1520, is an airflow grid lug 1522. Similarly, at each end of the grid branch 1517 that is opposite the airflow grid extensions 1518 is an airflow grid lug 1522.

The airflow grid 1504 may be positioned in proximity to a vent, duct (sometimes referenced as ductwork), or opening that is coupled to a fan. At the center of the airflow grid 1504 is an airflow grid center point 1520, and adjacent to the airflow grid center point 1520 is the sensor pod 1563 that allow for airflow measurements to be provided to an airflow sensor (not shown). In some examples, there may be multiple measurement points along the airflow grid 1504 that can be fluidly coupled to the sensor pod 1563. In some embodiment, a set of airflow grids 1504 may be utilized in conjunction with one another to measure across a large area of airflow that may be a plurality or a set of vents, ducts, or openings.

The airflow grid 1504 may be positioned in proximity to a vent, duct (sometimes referenced as ductwork), or opening that is coupled to a fan. At the center of the airflow grid 1504 is an airflow grid center point 1520, and adjacent to the airflow grid center point 1520 is the sensor pod 1563 that allow for airflow measurements to be provided to an airflow sensor (not shown). In some examples, there may be multiple measurement points along the airflow grid 1504 that can be fluidly coupled to the sensor pod 1563. In some embodiment, a set of airflow grids 1504 may be utilized in conjunction with one another to measure across a large area of airflow that may be a plurality or a set of vents, ducts, or openings.

FIG. 16A is a rear view of a modular multi-chamber airflow grid 1604. FIG. 16B is a cut away view of an airflow grid extension(s) 618 of the modular multi-chamber airflow grid 1604. FIG. 16C is a cutaway top view of a modular multi-chamber airflow grid 1604. FIG. 16D is a zoomed in cutaway top view of a modular multi-chamber airflow grid 1604. With respect to these figures, the chambers A 1664 and B 1665 shown in FIG. 16B can be fluidly coupled to the chamber sections 1666A/1666B shown in FIGS. 16C and 16D these chamber sections 1666A/1666B can be housed within the sensor pod 1663. The sensor pod 1663 can also house a computing device 1667 and various sensors 1668 that are coupled to the sensors via a set of sensor ports 1669A/1669B.

The chambers A 1664 and B 1665 can be coupled to the airflow measurement point(s) 1624 along the airflow grid extension 1618 can have a grid branches 1617. These allow for various or multiple measurements to be made and also determine a pressure differential. In at least one example, the sensor ports 1669A/1669B may be coupled (directly, indirectly, and/or fluidly) to the chamber sections 1666A/1666B and/or chambers A 1664 and B 1665. In other examples, the chamber sections 1666A/1666B are fluidly coupled to a pressure or airflow sensor, while the sensor ports 1669A/1669B are coupled to other environmental sensors.

A modular multi-chamber airflow grid 1604 can include two chambers, a chamber A and a chamber B. Chamber A and chamber B do not connect and are separate, which allows for them to provide a differential pressure. The rigid embedded differential pressure sensor has two separate air pressure ports. One port is connected to chamber A and one port is connected to chamber B. Each port is separate and not connected to the other. The connection between the pressure sensor and the pressure chambers is rigid and embedded and does not require tubing. The rigid attached node on the velocity grid can contain a MCU, environmental sensors, LED's, wireless communication, power source, and supporting electronics.

The modular multi-chamber airflow grid 1604 can include a sensor pod 1663 that allows for the airflow sensors, pressure sensors, differential pressure sensor, and other environmental sensors to be housed within the airflow grid 1604. The airflow grid 1604 can have an airflow grid center point 1620 that allows for airflow grid extensions 1618 to extend from it. While the airflow grid extensions 1618 are shown at right angles (or ninety (90) degrees) 1619A/1619B from each other, other angles may be used for more or fewer extensions. It would be understood that other angles can include but are not limited to 15, 30, 45, 60, 75, 90, 105, 120, 135, 150, 165, or 180 degrees. In at least one embodiment, there can be four airflow grid extensions(s) 1618, where each of the extensions are set ninety (90) degrees from each other. Meaning that the first extension is at 0 degrees, the second extension is at 90 degrees, the third extension is at 180 degrees, and the fourth extension is at 270 degrees.

At the end of the airflow grid extension(s) 1618 can be an airflow grid lug 1622 (may be referenced as a lug or grid lug). The airflow grid lug 1622 allows the airflow grid 1604 to be engaged or coupled to a set of connectors, such as but not limited to, the four-way connector or the two-way connector. In at least one embodiment, the airflow grid 1604 can have four airflow grid extensions 1618 and each airflow grid extension 1618 can have a grid branches 1617. As shown these grid branches 1617 are set at 90 degrees from each of the airflow grid extension 1618. In the present disclosure, there can be a first grid branch 1617 opposite a second grid branch, where the grid branch(es) 1617 are perpendicular to the airflow grid extensions 1618. When the grid branch(es) 1617 are perpendicular to the airflow grid extensions they may be referenced or called a cross member. While grid branch(es) 1617 are shown set at 90 degrees from each of the airflow grid extensions 1618, it would be understood that they could be placed at any angle from 0 to 180 degrees. It would be understood that other angles can include but are not limited to 15, 30, 45, 60, 75, 90, 105, 120, 135, 150, 165, or 180 degrees. In the present disclosure, there can be a first grid branch 1617 opposite a second grid branch, where the grid branch(es) 1617 are perpendicular to the airflow grid extensions 1618. This means that a first grid branch at 90 degrees to the airflow grid extension 1618, and then a second grid branch is at 180 degrees from the first grid branch, and 270 degrees from the airflow grid extensions.

The airflow grid 1604 allows for a measurement of airflow over a known surface area. In some examples, an airflow grid may also be known as an airflow measurement grid or air grid. In addition to airflow, the velocity of air movement across the airflow grid 1604 may also be measured. These measurements can be conducted through an airflow grid measurement point(s) 1624. In at least one example, each of the airflow grid extension(s) 1618 and each of the grid branch(es) 1617 can have an airflow grid measure point 1624. At the end of each airflow grid extension 1618 that is opposite the airflow grid center point 1620, is an airflow grid lug 1622. Similarly, at each end of the grid branch 1617 that is opposite the airflow grid extensions 1618 is an airflow grid lug 1622.

The airflow grid 1604 may be positioned in proximity to a vent, duct (sometimes referenced as ductwork), or opening that is coupled to a fan. At the center of the airflow grid 1604 is an airflow grid center point 1620, and adjacent to the airflow grid center point 1620 is the sensor ports 1669A/1669B that allow for airflow measurements to be provided to an airflow sensor (not shown). The sensor ports 1669A/1669 and/or chamber sections 1666A/1666B allow for airflow to be received by the airflow grid measurement point(s) 1624 and passed between the sensor ports 1669A/1669 and/or chamber sections 1666A/1666B. In some examples, there may be multiple measurement points along the airflow grid 1604 that can be fluidly coupled to the sensor ports 1669A/1669 and/or chamber sections 1666A/1666B. In some embodiment, a set of airflow grids 1604 may be utilized in conjunction with one another to measure across a large area of airflow that may be a plurality or a set of vents, ducts, or openings.

The airflow grid 1604 may be positioned in proximity to a vent, duct (sometimes referenced as ductwork), or opening that is coupled to a fan. At the center of the airflow grid 1604 is an airflow grid center point 1620, and adjacent to the airflow grid center point 1620 is the sensor ports 1669A/1669 and/or chamber sections 1666A/1666B that allow for airflow measurements to be provided to an airflow sensor (not shown). The sensor ports 1669A/1669 and/or chamber sections 1666A/1666B allow for airflow to be received by the airflow grid measurement point(s) 1624 and passed between the sensor ports 1669A/1669 and/or chamber sections 1666A/1666B. In some examples, there may be multiple measurement points along the airflow grid 1604 that can be fluidly coupled to the sensor ports 1669A/1669 and/or chamber sections 1666A/1666B. In some embodiment, a set of airflow grids 1604 may be utilized in conjunction with one another to measure across a large area of airflow that may be a plurality or a set of vents, ducts, or openings.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A modular airflow sensor array comprising:
at least two airflow grids with each having at least one airflow passage,
wherein the at least two airflow grids each have at least two extensions extending from a central point;
wherein the at least two extensions each have a lug on the end opposite the central point;
a two-way connector capable of engaging with the lug of one of the at least two extensions;
a support assembly that can couple with the two-way connector; and
a four-way connector that couples the at least two airflow grids together using the lug at the end of two of the at least two extension of each of the airflow grids.

2. The modular airflow sensor array of claim 1, wherein the at least two airflow grids further comprise a first extension, a second extension that is set 90 degrees from the first extension, a third extension that is set 90 degrees from the second extension and 180 degrees from the first extension, and a fourth extension that is 90 degrees from the third extension and 270 degrees from the first extension.

3. The modular airflow sensor array of claim 1, wherein each of the at least two extensions have a cross member that is set at 90 degrees from the direction of the at least two extensions.

4. The modular airflow sensor array of claim 3, wherein the cross member has a lug at the end of each cross member opposite the at least two extensions.

5. The modular airflow sensor array of claim 1, wherein the two-way connector further comprises two lug engagement sections that are on opposing ends of the two-way connector.

6. The modular airflow sensor array of claim 1, wherein the four-way connector further comprises a first engagement section, a second engagement section that is set at 90 degrees from the first engagement section, a third engagement section that is set at 90 degrees from the second engagement section; and a fourth engagement section that is set at 90 degrees from the third engagement section.

7. The modular airflow sensor array of claim 1, wherein the support assembly is a frame.

8. A modular airflow sensor system comprising:
at least two airflow grids having at least one airflow passages, wherein the at least two airflow grids have at least two extensions extending from a central point;
wherein the at least two extensions have a lug on the end opposite the central point;
a two-way connector capable of engaging with the lug of one of the at least two extensions;
a support assembly that can couple with the two-way connector;
a four-way connector that couples the at least two airflow grids together using the lug at the end of two of the at least two extensions of each of the airflow grids;
at least one airflow sensor coupled to each of the at least one airflow passages; and
a computing device connected to the at least one airflow sensor for processing of data captured from the at least one airflow sensor.

9. The modular airflow sensor system of claim 8, wherein the at least two airflow grids further comprise a first extension, a second extension that is set 90 degrees from the first extension, a third extension that is set 90 degrees from the second extension and 180 degrees from the first extension, and a fourth extension that is 90 degrees from the third extension and 270 degrees from the first extension.

10. The modular airflow sensor system of claim 8, wherein each of the at least two extensions have a cross member that is set at 90 degrees from the direction of the at least two extensions.

11. The modular airflow sensor system of claim 10, wherein the cross member has a lug at the end of each cross member opposite the at least two extensions.

12. The modular airflow sensor system of claim 8, wherein the two-way connector further comprises two lug engagement sections that are on opposing ends of the two-way connector.

13. The modular airflow sensor system of claim 8, wherein the four-way connector further comprises a first engagement section, a second engagement section that is set at 90 degrees from the first engagement section, a third engagement section that is set at 90 degrees from the second engagement section; and a fourth engagement section that is set at 90 degrees from the third engagement section.

14. The modular airflow sensor system of claim 8, wherein the support assembly is a frame.

15. A method of assembly of an airflow sensor array comprising:
taking a frame that fits an airflow area to be measured;
fitting at least one airflow grid to the frame;
coupling the at least one airflow grid to a measurement device;
wherein the at least one airflow grid each have at least two extensions extending from a central point;
engaging a lug at the opposing end of the at least two extensions from the central point with a connector; and
conducting measurements of airflow across the airflow area.

16. The method of assembly of claim 15, wherein engaging further comprises a two-way connector that engages with the lug and engages with the frame.

17. The method of assembly of claim 15, wherein engaging further comprises a four-way connector that engages with the lug and engages with the frame.

18. The method of assembly of claim 15, wherein the measurement device allows for measurement of air volume.

19. The method of assembly of claim 15, wherein the measurement device allows for measurement of air speed.

20. The method of assembly of claim 15, further comprising coupling multiple airflow grids together by a connector.
